(19) United States
(12) Patent Application Publication
(10) Pub. No.: US 2020/0110924 A1
(43) Pub. Date: Apr. 9, 2020

(54) EMBRYONIC DEVELOPMENT ANALYSIS SYSTEM, EMBRYONIC DEVELOPMENT IMAGE ANALYSIS METHOD, NON-TRABSITORY COMPUTER READABLE MEDIUM, AND EMBRYONIC DEVELOPMENT ANALYSIS IMAGE PROCESSING DEVICE

(71) Applicant: Sony Corporation, Tokyo (JP)

(72) Inventors: Masataka Shinoda, Kanagawa (JP); Takeshi Ohashi, Kanagawa (JP); Tomoya Onuma, Shizuoka (JP)

(73) Assignee: Sony Corporation, Tokyo (JP)

(21) Appl. No.: 16/496,713

(22) PCT Filed: Jan. 26, 2018
(86) PCT No.: PCT/JP2018/002469

§ 371 Date: Sep. 23, 2019

(30) Foreign Application Priority Data
Mar. 31, 2017 (JP) 2017-072856

(51) Int. Cl. G06K 9/00; G06K 9/62; G06T 7/70; G06T 7/00; G06T 7/60

(52) U.S. Cl. CPC G06K 9/00147; G06K 9/627; G06T 7/70; G06T 2207/10056; G06T 7/60; G06T 2207/30024; G06T 7/0016

(57) ABSTRACT

There is provided an embryonic development analysis system, including: processing circuitry configured to: recognize a shape of one or more cells represented in one or more of a plurality of embryonic development images captured in a time series; calculate a time-series change of the shape of the one or more cells based on the recognized shape of the one or more cells in the one or more of the plurality of embryonic development images; and calculate a first feature amount based on the calculated time-series change of the shape.

### CROSS REFERENCE TO RELATED APPLICATIONS

This application claims the benefit of Japanese Priority Patent Application JP 2017-072856 filed Mar. 31, 2017, the entire contents of which are incorporated herein by reference.

### TECHNICAL FIELD

The present technique relates to an information processing apparatus, an information processing method, a program, and an observation system applicable to evaluation of a cell or the like.

### BACKGROUND ART

According to Patent Literature 1, a reference image is selected from an image group, which includes captured images of a plurality of fertile ova, and the profile of the fertile ovum of the selected reference image is detected as a reference profile. A predetermined profile processing is executed with reference to the reference profile, and the profile of the fertile ovum of an arbitrary image of the image group is therefore determined. As a result, the positions of the fertile ovum of all the images of the image group are matched accurately, and therefore it is possible to output such fertile ovum images. The accuracy of analysis of a fertile ovum may be therefore increased.

### CITATION LIST

### Patent Literature

PTL 1: Japanese Patent Application Laid-open No. 2011-192109

### SUMMARY

### Technical Problem

It is desirable to provide a technique for evaluating a fertile ovum under observation or the like with a high degree of accuracy.

In view of the above-mentioned circumstances, it is desirable to provide an information processing apparatus, an information processing method, a program, and an observation system with which a fertile ovum under observation can be evaluated with a high degree of accuracy.

### Solution to Problem

According to an embodiment of the present technique, there is provided an embryonic development analysis system, including: processing circuitry configured to: recognize a shape of one or more cells represented in one or more of a plurality of embryonic development images captured in a time series; calculate a time-series change of the shape of the one or more cells based on the recognized shape of the one or more cells in the one or more of the plurality of embryonic development images; and calculate a first feature amount based on the calculated time-series change of the shape.

According to the above-mentioned technique, the quality of the fertile ovum may be multilaterally evaluated in view of not only morphological findings of the fertile ovum but also the shape-change of the fertile ovum. The fertile ovum under observation may be evaluated with a high degree of accuracy.

The processing circuitry may be configured to calculate a time-series change of at least one of: a diameter, an area, a volume, and roundness of the one or more cells. Therefore, where they are visualized in a graph or the like, a user may confirm the start time of the change of the shape of the fertile ovum, the growing speed, and the like. The user may know the contractile activity of the fertile ovum in time series.

The processing circuitry may be configured to calculate at least one of: a number of times of contraction, a contraction diameter, contraction speed, a contraction time period, contraction intervals, contraction strength, and contraction frequency of the one or more cells. Therefore, where they are visualized as in a graph or the like, a user may quantitatively and objectively confirm minute contract phenomena of the fertile ovum.

The processing circuitry may be further configured to determine a quality of the one or more cells based, at least in part, on the first feature amount. Therefore, the processing circuitry is capable of automatically determining the quality of the fertile ovum on the basis of the first feature amount output from the feature amount calculating unit by using the quality result determined on the basis of the morphological findings of an embryologist.

The processing circuitry may be configured to determine the quality of the one or more cells by using a trained model trained in accordance with a machine learning algorithm. Therefore the fertile ova may be evaluated with a high degree of accuracy.

The processing circuitry may be configured to calculate at least one of: a central coordinate, a movement amount, a motion amount, a movement distance, movement speed, movement acceleration, and a movement locus of the one or more cells. Therefore, where they are visualized, a user may confirm the motion ability of the fertile ovum in the well.

The processing circuitry may be further configured to calculate a time-series change of an inner movement amount of components of the one or more cells as represented in the one or more of the plurality of embryonic development images. Therefore, where the change of the movement amount is visualized in the graph or the like, it is possible to evaluate the motion ability of the inside of the fertile ovum where the outline of the fertile ovum less changes.

The processing circuitry may be further configured to determine one or both of an active period and an inactive period of the one or more cells based on the time-series change of the shape of the one or more cells and the time-series change of the inner movement amount. Therefore it is possible to automatically determine a lag-phase period (inactive period), the lag-phase period being an indicator to select a fertile ovum, which is predicted to have a high genesis ability after implantation.

The processing circuitry may be further configured to calculate at least one of an incubation rate, an implantation rate, a pregnancy rate, a conception rate, a miscarriage rate, a birthweight, a birth rate, and a breeding value of a grown-up of the one or more cells on the basis of at least one of the time-series change of shape of the one or more cells and the first feature amount. As a result, efficiency of selecting operation of the fertile ovum, which is predicted to have a high genesis ability after implantation, is increased significantly.

The processing circuitry may be further configured to calculate at least one of the incubation rate, the implantation rate, the pregnancy rate, the conception rate, the miscarriage rate, the birthweight, the birth rate, and the breeding value of a grown-up of the one or more cells using a trained model trained using a machine learning algorithm. As a result, it is possible to calculate a predictive value about the fertile ovum before implantation with a high degree of accuracy.

The processing circuitry may be further configured to recognize the shape of the one or more cells by forming mask areas for the plurality of embryonic development images, respectively, each of the mask areas being along a shape of the one or more cells, and calculate the time-series change of the shape of the one or more cells by calculating the time-series change of the shape based, at least in part, on a differential value between one of the mask areas and another one of the mask areas. As a result, the analysis area (recognition area) of each of the captured images of the fertile ovum is clarified, and the shape and the like of the fertile ovum may be recognized accurately. As a result, occurrence of noises and mis-detection is reduced when processing the images.

The embryonic development analysis system may further include control circuitry configured to control a timing of capturing embryonic development images by the imaging device based on the calculated time-series change of the shape of the one or more cells. Under the control, it is possible to irradiate the fertile ovum with light only at the time of obtaining data, which is very important to evaluate the quality of each of the fertile ovum. Therefore the total time period, in which the fertile ovum under observation is irradiated with light from the light source, is shortened, and photo-damages (phototoxicity) to the fertile ova are reduced.

The processing circuitry may be configured to calculate at least one of an area of a zona pellucida, an area of inner daughter cells, an area of an inner morula, and an area of an inner blastocyst of the one or more cells.

The processing circuitry may be further configured to determine compaction of the one or more cells on the basis of change of a differential or a ratio of at least one of an area of a zona pellucida, an area of inner daughter cells, an area of an inner morula, and an area of an inner blastocyst of the fertile ovum.

The processing circuitry may be further configured to determine cell-division time, a number of daughter cells, a symmetric property of daughter cells, or fragmentation of daughter cells of the fertile ovum on the basis of change of a differential or a ratio of at least one of an area of a zona pellucida and an area of inner daughter cells of the fertile ovum.

The processing circuitry may be further configured to preprocess the one or more of the plurality of embryonic development images; and calculate the time-series shape change of the one or more cells using the preprocessed one or more embryonic development images.

The processing circuitry may be further configured to calculate a time-series change in the shape of a fertile ovum in the plurality of embryonic development images.

The embryonic development analysis system may further include an imaging device configured to capture the plurality of embryonic development images in a time series.

Further, according to an embodiment of the present disclosure, there is provided an embryonic development image analysis method, including: obtaining a plurality of embryonic development images captured in time series; recognizing a shape of one or more cells represented in one or more of the plurality of embryonic development images; calculating a time-series change of the shape of the one or more cells based on the recognized shape of the one or more cells in the one or more of the plurality of embryonic development images; and calculating a first feature amount based on the calculated time-series change of the shape.

Further, according to an embodiment of the present disclosure, there is provided a non-transitory computer readable medium having stored thereon a program that when executed by a computer causes the computer to execute processing, the processing including: obtaining a plurality of embryonic development images captured in time series; recognizing a shape of one or more cells represented in one or more of the plurality of embryonic development images; calculating a time-series change of the shape of the one or more cells based on the recognized shape of the one or more cells in the one or more of the plurality of embryonic development images; and calculating a first feature amount based on the calculated time-series change of the shape.

Further, according to an embodiment of the present disclosure, there is provided an embryonic development image processing device, including: processing circuitry configured to:recognize a shape of one or more cells represented in one or more of the plurality of embryonic development images; calculate a time-series change of the shape of the one or more cells based on the recognized shape of the one or more cells in the one or more of the plurality of embryonic development images; and calculate a first feature amount based on the calculated time-series change of the shape.

### Advantageous Effects

As described above, according to the present technique, it is possible to provide an information processing apparatus, an information processing method, a program, and an observation system with which a fertile ovum under observation can be evaluated with a high degree of accuracy. These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram schematically showing a configuration example of the observation system according to a first embodiment of the present technique.

FIG. 2 is a diagram schematically showing the culture dish group mounted on the observation stage of the observation device seen from the light source side.

FIG. 3 is a diagram schematically showing a cross-section of the culture dish of this embodiment.

FIG. 4 is a diagram schematically showing the culture dish seen from the light source side.

FIG. 5 is an enlarged diagram schematically showing the image-capture area of the culture dish seen from the light source side.

FIG. 6 is a function block diagram showing a configuration example of the observation system.

FIG. 7 is a flowchart showing a method of evaluating quality of each of the fertile ova by the image processing apparatus of this embodiment.

FIG. 8 is a diagram schematically showing how the image-capture unit of the observation system captures images of the plurality of fertile ova.

FIG. 9 is a diagram virtually and conceptionally showing the plurality of first time-series images of the present technique.

FIG. 10 is a diagram virtually and conceptionally showing the plurality of second time-series images of the present technique.

FIG. 11 is a diagram schematically showing the graph, which visualizes time-series transformation of the fertile ovum of this embodiment.

FIG. 12 is a diagram schematically showing the graph, which visualizes the first feature amount of the fertile ovum of this embodiment.

FIG. 13 is a diagram, which schematically visualizes the second feature amount of the fertile ovum of a second embodiment of the present technique.

FIG. 14 is a diagram schematically showing the the graph, which visualizes the change of an inner movement amount of the fertile ovum of a third embodiment of the present technique.

FIG. 15 is a diagram illustrating shape-change of a growing fertile ovum.

FIG. 16 is a diagram schematically showing both the graph, which visualizes time-series transformation of the fertile ovum, and the graph, which visualizes change of the inner movement amount of the fertile ovum, of a fifth embodiment of the present technique.

FIG. 17 is a diagram schematically showing a configuration example of the observation system according to a sixth embodiment of the present technique.

### DESCRIPTION OF EMBODIMENTS

Hereinafter, embodiments of the present technique will be described with reference to the drawings. In the drawings, perpendicular X axis, Y axis, and Z axis are shown as necessary. The X axis, the Y axis, and the Z axis are common in all the drawings.

### First Embodiment

(Configuration of Observation System)

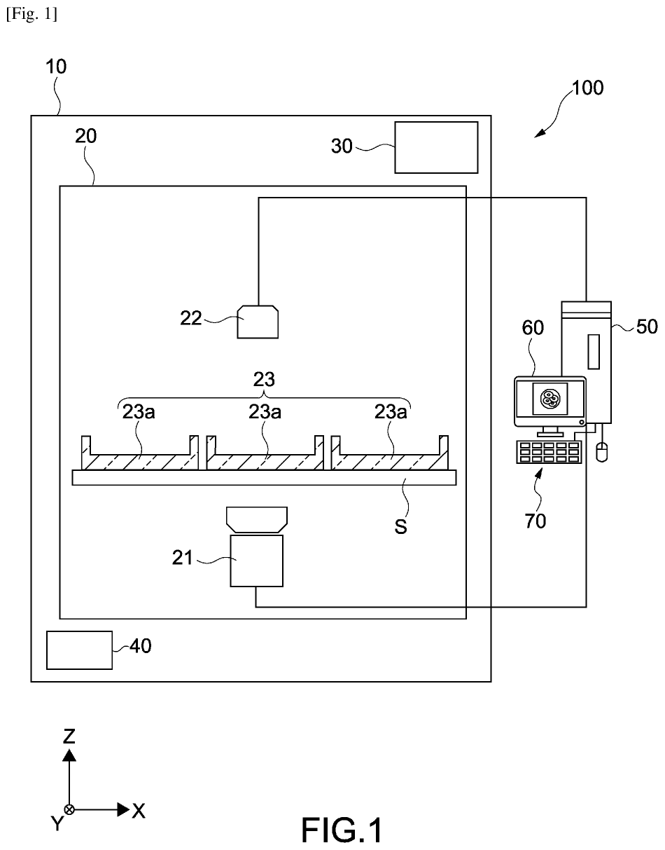

FIG. 1 is a diagram schematically showing a configuration example of the observation system 100 according to a first embodiment of the present technique. As shown in FIG. 1, the observation system 100 includes the incubator 10, the observation device 20, the humidity-temperature-gas controller unit 30, the detector unit 40, the image processing apparatus 50, the display device 60, and the input unit 70.

The incubator 10 is a culturing device, in which the observation device 20, the humidity-temperature-gas controller unit 30, and the detector unit 40 are housed, and has a function of keeping the temperature, the humidity, and the like of the inside of the culturing device constant. The incubator 10 allows arbitrary gas to flow into the incubator 10. The kind of the gas is not specifically limited and is, for example, nitrogen, oxygen, carbon dioxide, or the like.

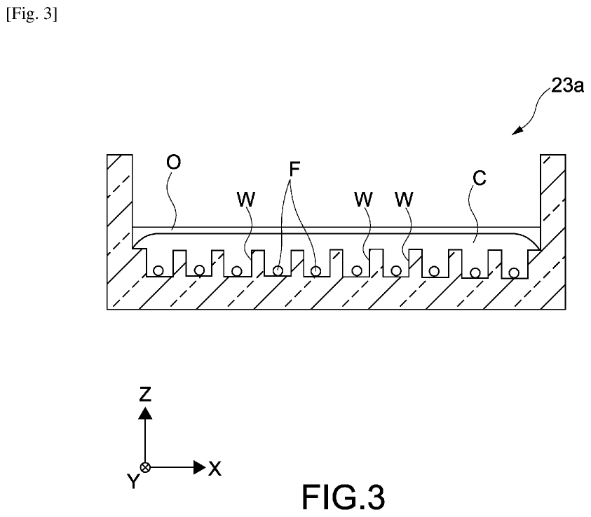

The observation device 20 includes the image-capture unit 21, the light source 22, and the culture dish group 23. The image-capture unit 21 is configured to capture images of the fertile ova F (see FIG. 3) held in the culture dish 23a (petri dish) in time series, and be capable of generating images of the fertile ova F.

The image-capture unit 21 includes a lens barrel, a solid state image sensor, a drive circuit that drives them, and the like. The lens barrel includes a group of lenses capable of moving in a light-axis direction (Z-axis direction). The solid state image sensor captures light from an object passing through the lens barrel, and is a CMOS (Complementary Metal Oxide Semiconductor), a CCD (Charge Coupled Device), or the like.

The image-capture unit 21 is configured to be capable of moving in the light-axis direction (Z-axis direction) and the horizontal direction (direction perpendicular to Z-axis direction). The image-capture unit 21 captures images of the fertile ova F held in the culture dish 23a while moving in the horizontal direction. Further, the image-capture unit 21 may be configured to be capable of capturing not only still images but also motion images.

Typically, the image-capture unit 21 of the present embodiment is a visible camera. Not limited to this, the image-capture unit 21 may be an infrared (IR) camera, a polarization camera, or the like.

When the image-capture unit 21 captures images of the fertile ova F in the culture dish 23a, the light source 22 irradiates the culture dish 23a with light. The light source 22 is an LED (Light Emitting Diode) or the like that irradiates the culture dish 23a with light having a certain wavelength, for example. Where the light source 22 is an LED, for example, a red LED that irradiates the culture dish 23a with light having a wavelength of 640 nm is used.

The culture dish group 23 includes the plurality of culture dishes 23a. The culture dish group 23 is mounted on the observation stage S between the image-capture unit 21 and the light source 22. The observation stage S is transparent, and allows the light emitted from the light source 22 to pass therethrough.

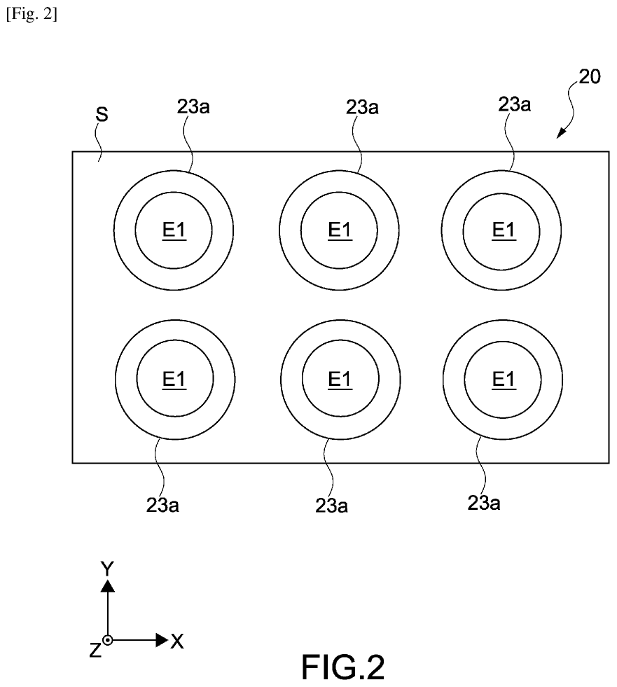

FIG. 2 is a diagram schematically showing the culture dish group 23 mounted on the observation stage S of the observation device 20 seen from the light source 22 side. As shown in FIG. 2, for example, the six culture dishes 23a are mounted on the observation stage S in a matrix, i.e., three in the X-axis direction and two in the Y-axis direction.

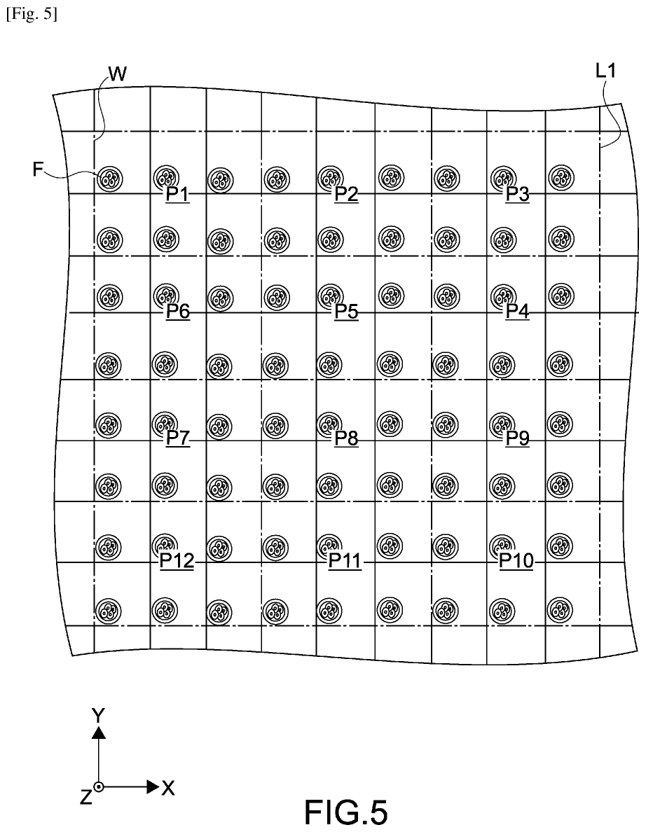

FIG. 3 is a diagram schematically showing a cross-section of the culture dish 23a. As shown in FIG. 3, the culture dish 23a has the plurality of wells W. The wells W of the culture dish 23a are arrayed in a matrix (see FIG. 5). Each well W is capable of holding one fertile ovum F.

The culture solution C and the oil O are injected into the culture dish 23a having the wells W. The oil O coats the culture solution C to thereby have a function of preventing the culture solution C from evaporating.

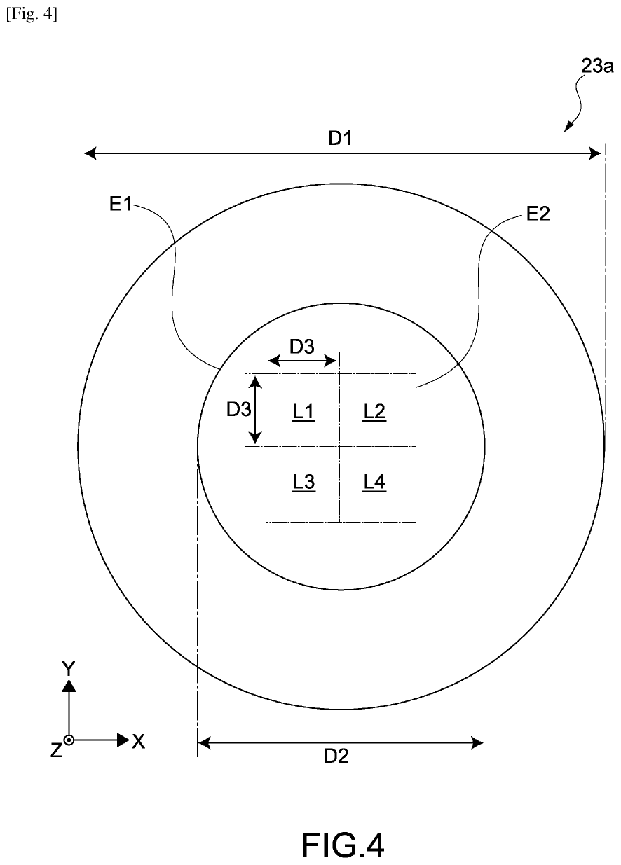

FIG. 4 is a diagram (plan view) schematically showing the culture dish 23a seen from the light source 22 side. The culture dish 23a has the well area E1 in which the plurality of wells W are formed. The diameter D1 of the culture dish 23a and the diameter D2 of the well area E1 are not particularly limited. For example, the diameter D1 is about 35 mm, and the diameter D2 is about 20 mm.

The well area E1 has the image-capture region E2, the image-capture unit 21 taking images of the image-capture region E2. As shown in FIG. 2, the image-capture region E2 is equally divide into four image-capture areas L1 to L4. The length D3 of one side of each of the image-capture areas L1 to L4 is, for example, about 5 mm.

FIG. 5 is an enlarged diagram schematically showing the image-capture area L1 seen from the light source 22 side. The image-capture area L1 includes the 72 wells W out of the plurality of wells W in the well area E1, and is equally divided into twelve POS (position) areas.

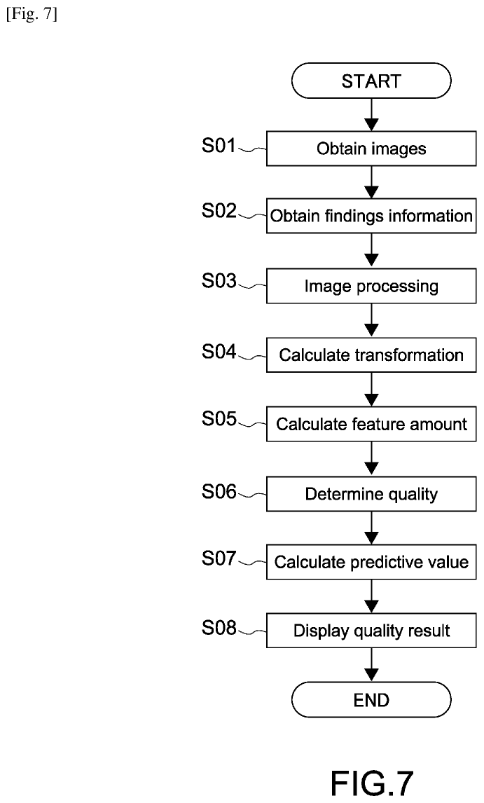

Each of the POS areas P1 to P12 includes the six wells W, i.e., three wells W in the X-axis direction and two wells W in the Y-axis direction. According to the present embodiment, in the image obtaining step (described later) (see FIG. 7), the image-capture unit 21 captures images of the fertile ova F held in the wells W of each POS area in time series. Note that FIG. 5 is a diagram schematically showing the enlarged image-capture area L1. The structure of each of the image-capture areas L2 to L4 is similar to the structure of the image-capture area L1.

The material of the culture dish 23a is not particularly limited. The culture dish 23a is made from, for example, an inorganic material such as glass and silicon, or made from an organic material such as polystyrene resin, polyethylene resin, polypropylene resin, ABS resin, nylon, acrylic resin, fluororesin, polycarbonate resin, polyurethane resin, methylpentene resin, phenol resin, melamine resin, epoxy resin, vinyl chloride resin, and other organic materials. The culture dish 23a is a transparent material that allows the light emitted from the light source 22 to pass therethrough. Alternatively, a part of the culture dish 23a, through which no light emitted from the light source 22 passes, may be made from the above-mentioned materials or made from a metal material.

The humidity-temperature-gas controller unit 30 is configured to control the temperature and the humidity of the inside of the incubator 10 and gas introduced into the incubator 10 to thereby make the environment appropriate to growing of the fertile ovum F. The humidity-temperature-gas controller unit 30 is capable of controlling the temperature of the incubator 10 at about 38° C., for example.

The detector unit 40 is wirelessly connected to the image processing apparatus 50, and is configured to detect the temperature, the humidity, and the atmospheric pressure of the inside of the incubator 10, the illuminance of the light source 22, and the like, and output the detected results to the image processing apparatus 50. The detector unit 40 is, for example, a solar-panel-driven or battery-driven IoT (Internet of Things) sensor or the like, and may be of any kind.

The image processing apparatus 50 includes hardware necessary for a computer such as a CPU (Central Processing Unit), a ROM (Read Only Memory), a RAM (Random Access Memory), and an HDD (Hard Disk Drive). When the CPU loads a program of the present technique stored in the ROM or the HDD in the RAM and executes the program, the CPU controls operations of the respective blocks (described later) of the image processing apparatus 50.

For example, the program stored in any kind of a recording medium (internal memory) is installed in the image processing apparatus 50. Alternatively, the program may be installed via the Internet or another network. In the present embodiment, for example, the image processing apparatus 50 is a PC (Personal Computer) or the like, but the image processing apparatus 50 may be an arbitrary computer other than a PC.

The display device 60 is configured to be capable of displaying images and the like captured by the image-capture unit 21. The display device 60 is, for example, a liquid crystal display device, an organic EL (Electro-Luminescence) display device, or the like.

The input unit 70 includes operation devices such as a keyboard and a mouse in which operations are input by a user. In the present embodiment, the input unit 70 may be a touch panel or the like with the display device 60.

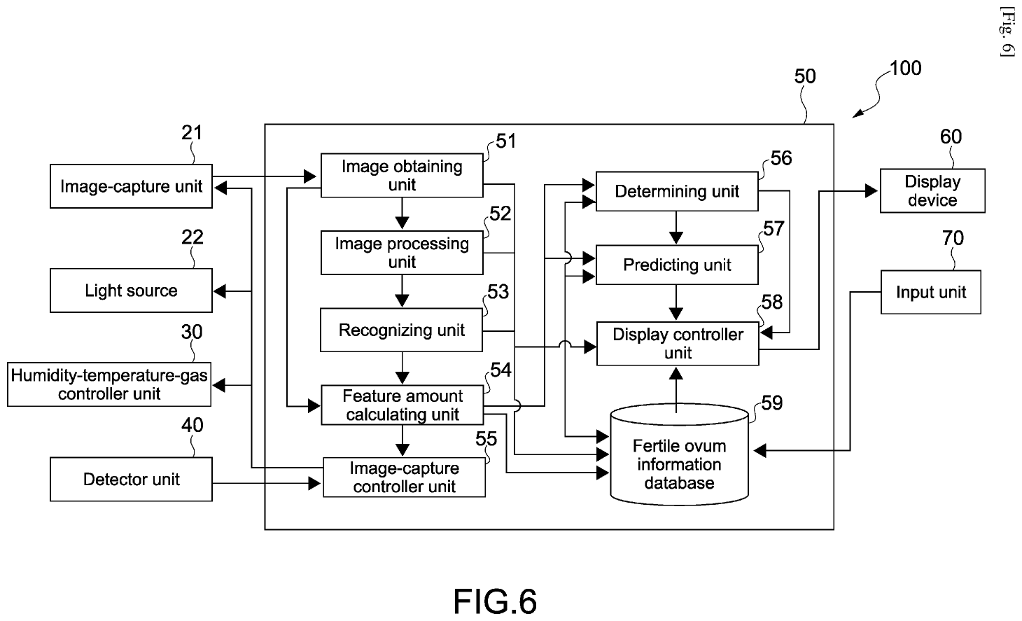

Next, a configuration of the image processing apparatus 50 will be described. FIG. 6 is a function block diagram showing a configuration example of the observation system 100.

(Image Processing Apparatus)

As shown in FIG. 6, the image processing apparatus 50 includes the image obtaining unit 51, the image processing unit 52, the recognizing unit 53, the feature amount calculating unit 54, the image-capture controller unit 55, the determining unit 56, the predicting unit 57, the display controller unit 58, and the fertile ovum information database 59.

The image obtaining unit 51 is configured to obtain images of the fertile ova F captured in time series by the image-capture unit 21. The image processing unit 52 is configured to process (trim) the images obtained from the image obtaining unit 51.

The recognizing unit 53 is configured to analyze the images obtained from the image obtaining unit 51 in a predetermined way, and recognize at least one of a shape of each of the fertile ova F and a position of each of the fertile ova F in each of the wells W on the basis of the images.

The feature amount calculating unit 54 is configured to calculate at least one of time-series transformation of each of the fertile ova F and time-series change of a relative position of each of the fertile ova F relative to each of the wells W, each of the fertile ova F being held in each of the wells W, and calculate at least one of a feature amount based on the transformation (hereinafter referred to as first feature amount) and a feature amount based on the change of the relative position (hereinafter referred to as second feature amount).

The image-capture controller unit 55 is configured to control the image-capture unit 21 and the light source 22 on the basis of the shape-change (transformation), time of capturing the images of the fertile ova F being changed under the control.

For example, the image-capture controller unit 55 controls the image-capture unit 21 and the light source 22 on the basis of numerical data of shape-change output from the feature amount calculating unit 54, the image-capture intervals of capturing images of the fertile ova F being shortened under the control. Under the control, it is possible to irradiate the fertile ova F with light only at the time of obtaining data, which is very important to evaluate the quality of each of the fertile ova F. Therefore the total time period, in which the fertile ova F under observation are irradiated with light from the light source 22, is shortened, and photo-damages (phototoxicity) to the fertile ova F are reduced.

The photo-damages (phototoxicity) include photo-damages, thermal damages, and other damages to DNA and chromosomes affected by light. The image-capture controller unit 55 may control the image-capture unit 21 and the light source 22 on the basis of not only shape-change of the fertile ova F in time series but also time of capturing the fertile ova F, the growth stages, and the like.

Further, the image-capture controller unit 55 is configured to be also capable of controlling the light source 22 and the humidity-temperature-gas controller unit 30 on the basis of output from the detector unit 40. As a result, the temperature and the humidity of the inside of the incubator 10 and the illuminance of the light source 22 are adjusted.

The determining unit 56 is configured to determine quality of each of the fertile ova F on the basis of at least one of the first feature amount and the second feature amount.

The predicting unit 57 is configured to calculate at least one of an incubation rate, an implantation rate, a pregnancy rate, a conception rate, a miscarriage rate, a birthweight, a birth rate, a breeding value of a grown-up, and the like of each of the fertile ova F on the basis of at least one of the transformation, the first feature amount, and the second feature amount output from the feature amount calculating unit 54.

The fertile ovum information database 59 is configured store the images obtained from the image obtaining unit 51, the transformation and the feature amounts obtained from the feature amount calculating unit 54, input information input from the input unit 70, and the like.

(Quality Evaluation)

FIG. 7 is a flowchart showing a method of evaluating quality of each of the fertile ova F by the image processing apparatus 50. With reference to FIG. 7 as necessary, a method of evaluating quality of each of the fertile ova F will be described hereinafter.

(Step S01: Obtain Images)

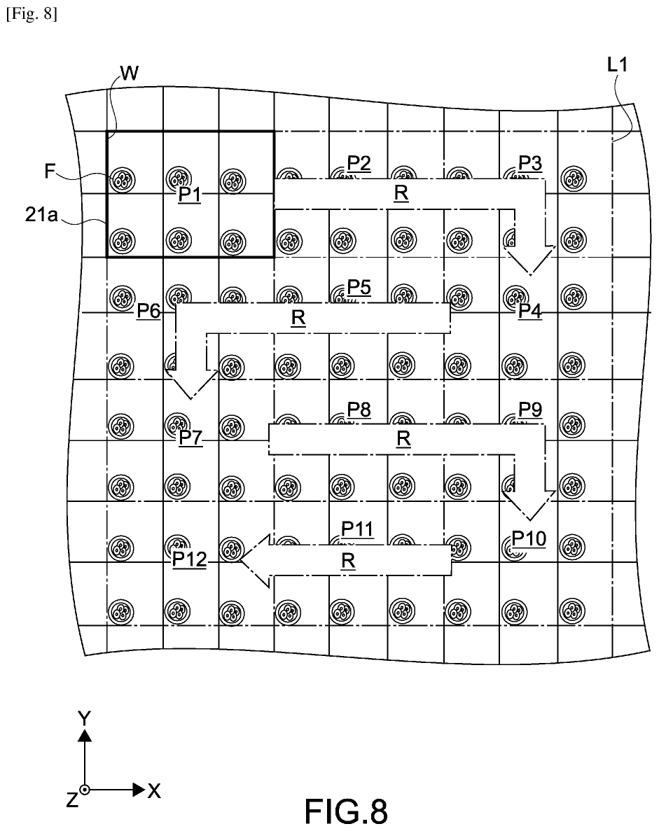

FIG. 8 is a diagram schematically showing how the image-capture unit 21 captures images of the plurality of fertile ova F, and showing a route of the image-capture unit 21 moving.

Firstly, the image-capture unit 21 captures the plurality of fertile ova F held in the plurality of wells W one-to-one for each POS (Position) area in time series. As shown in FIG. 8, at this time, the field-of-view range 21a of the image-capture unit 21 moves in the order from the POS area P1 to the POS area P12 at intervals of about 3 seconds along the the moving route R.

Then this process is executed for all the culture dishes 23a mounted on the observation stage S, which is repeated a predetermined times. As a result, a plurality of images (hereinafter referred to as the first time-series images G1), each including six fertile ova F, are generated. The plurality of first time-series images G1 are transferred to the image obtaining unit 51 (the image processing apparatus 50).

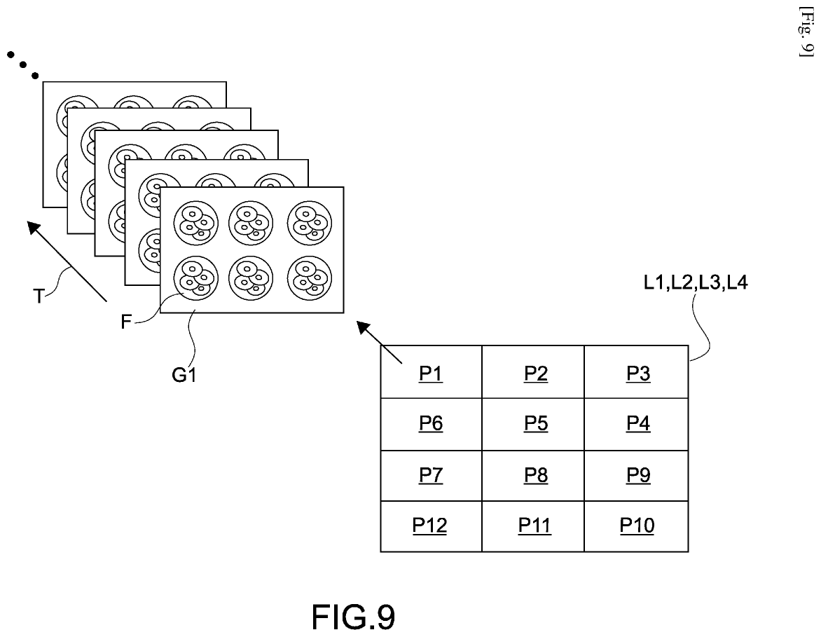

FIG. 9 is a diagram virtually and conceptionally showing the plurality of first time-series images G1. As shown in FIG. 9, in the present embodiment, the plurality of first time-series images G1 are generated in time series along the time axis T for each of the POS areas P1 to P12. In the present description, the image group shown in FIG. 9 will be referred to as the plurality of first time-series images G1.

The image-capture intervals and the number of capture of the image-capture unit 21 of the observation system 100 may be arbitrarily configured. For example, the image-capture time period is 1 week, the image-capture interval is 15 minutes, and 9 stacks of images are captured where the focal length is changed in the depth direction (Z-axis direction). In this case, about 6000 stacked images each including six fertile ova F are obtained for each one of the POS areas. As a result, three-dimensional images of the fertile ova F may be obtained.

The image obtaining unit 51 outputs the plurality of first time-series images G1, which are transferred from the image-capture unit 21, to the image processing unit 52 and the fertile ovum information database 59. The fertile ovum information database 59 stores the plurality of first time-series images G1.

(Step S02: Obtain Findings Information)

The display controller unit 58 retrieves the plurality of first time-series images G1 stored in the fertile ovum information database 59, and outputs the plurality of first time-series images G1 to the display device 60. Then the display device 60 displays the plurality of first time-series images G1.

Next, a specialist such as an embryologist evaluates the quality (growth state, number of cells, cell symmetric property, fragment, etc.) of each fertile ovum F on the basis of his/her morphological findings with reference to the plurality of first time-series images G1 displayed on the display device 60. The evaluation result of the fertile ovum F, which is evaluated by the embryologist, is input in the input unit 70 and output to the fertile ovum information database 59. The evaluation result of the fertile ovum F is stored in the fertile ovum information database 59 and treated as first quality data about the fertile ovum F.

Note that, in the present embodiment, a method of evaluating quality of the fertile ovum F by an embryologist is not particularly limited. For example, in Step S02, typically, an embryologist evaluates qualities of all the six fertile ova F in the first time-series images for each of the POS areas P1 to P12. Not limited to this, an embryologist may evaluate qualities of some of the fertile ova F. Further, an embryologist may refer to all or some of the stacked images of the 9 stacks of each fertile ovum F to evaluate the fertile ovum F.

(Step S03: Image Processing)

The image processing unit 52 processes (trims) the plurality of first time-series images G1 obtained from the image obtaining unit 51 for a unit of the fertile ovum F. As a result, the image processing unit 52 generates a plurality of images each including one fertile ovum F (hereinafter referred to as the second time-series images G2). Next, the image processing unit 52 outputs the plurality of second time-series images G2 to the recognizing unit 53 and the fertile ovum information database 59. The fertile ovum information database 59 stores the plurality of second time-series images G2.

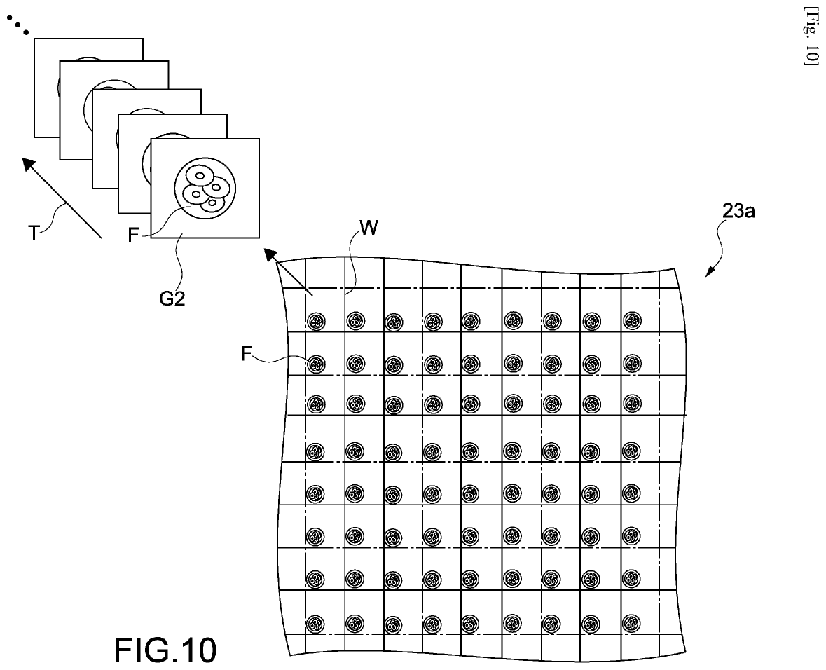

FIG. 10 is a diagram virtually and conceptionally showing the plurality of second time-series images G2. As shown in FIG. 10, in the present embodiment, the plurality of second time-series images G2 are generated in time series along the time axis T for each of the plurality of wells W. In the present description, the image group shown in FIG. 10 will be referred to as the plurality of second time-series images G2.

The recognizing unit 53 processes the plurality of second time-series images G2 obtained from the image processing unit 52 in a predetermined way. The recognizing unit 53 outputs the plurality of second time-series images G2 having been processed to the feature amount calculating unit 54 and the fertile ovum information database 59. The fertile ovum information database 59 stores the plurality of second time-series images G2 having been processed.

For example, the recognizing unit 53 processes the plurality of second time-series images G2 obtained from the image processing unit 52 by means of probability process based on a deep learning analysis, binarizing process, overlay process, and the like. As a result, for example, profiles of the fertile ova F are extracted from the second time-series images G2.

Alternatively, the recognizing unit 53 is configured to form mask areas for the plurality of second time-series images G2, respectively, each of the mask areas being along a shape of each of the fertile ova F. As a result, the analysis area (recognition area) of the fertile ovum F of each of the second time-series images G2 is clarified, and the shape of the fertile ovum F may be recognized accurately. By employing this technique, the recognizing unit 53 of the present embodiment may accurately recognize shapes of a zona pellucida that forms the outline of the fertile ovum F, a blastocyst, daughter cells, and a morula inside the fertile ovum F, and the like, for example.

(Step S04: Calculate Transformation)

The feature amount calculating unit 54 analyzes the plurality of second time-series images G2 output from the recognizing unit 53 in a predetermined way, and thereby calculates shape-change (transformation) of the fertile ovum F along the time axis T. The feature amount calculating unit 54 outputs numerical data about the shape-change to the image-capture controller unit 55, the determining unit 56, the predicting unit 57, the display controller unit 58, and the fertile ovum information database 59. The fertile ovum information database 59 stores the numerical data output from the feature amount calculating unit 54 as reference data in the fertile ovum information database 59.

For example, the feature amount calculating unit 54 calculates inter-frame differential values of the plurality of second time-series images G2 output from the recognizing unit 53, and calculates the shape-change on the basis of the differential value.

Alternatively, the feature amount calculating unit 54 may calculate a differential value between the mask area of one second time-series image and the mask area of another second time-series image of the plurality of mask areas formed on the plurality of second time-series images G2 in the above-mentioned Step S03. In other words, the feature amount calculating unit 54 may calculate inter-frame differential values of only the mask areas along the shapes of the fertile ova F, and calculate the shape-change on the basis of the differential value.

As a result, occurrence of noises and mis-detection, which results from an inter-frame differential value calculated on the basis of the whole second time-series images G2, is reduced. The shape-change and a first feature amount (described later) of the fertile ovum F may be calculated accurately.

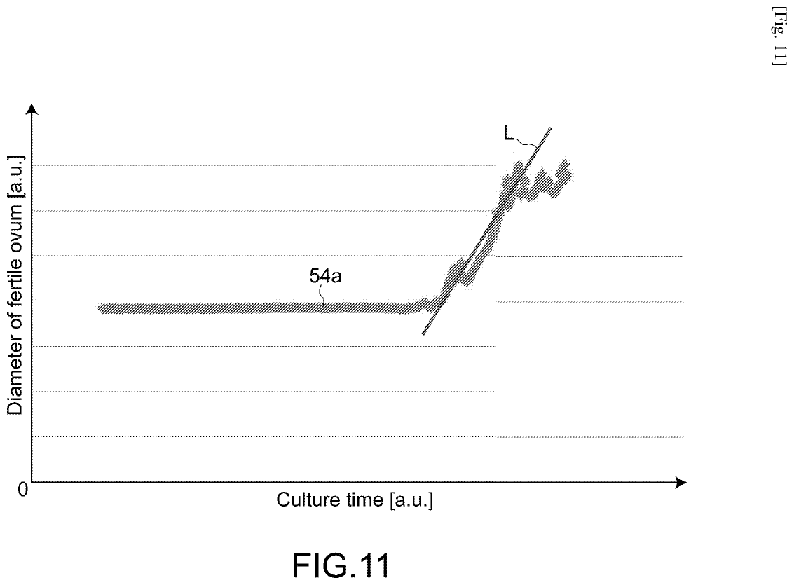

FIG. 11 is a diagram schematically showing the graph 54a, which visualizes the shape-change (change of diameter) of the fertile ovum F in time series with reference to the culture time. The feature amount calculating unit 54 is configured to calculate, as the shape-change, change of at least one of a diameter, an area, a volume, and roundness of the fertile ovum F in time series.

Therefore, since they are visualized as shown in the graph of FIG. 11 or the like, a user may confirm the start time of the change of the shape of the fertile ovum F, the growing speed, and the like. The user may know the contractile activity of the fertile ovum F in time series (for example, change of the radius of the fertile ovum F in time series, etc.). Note that, with reference to the example of FIG. 11, the inclination of the straight line L corresponds to the growing speed of the fertile ovum F.

(Step S05: Calculate Feature Amount)

Subsequently, the feature amount calculating unit 54 analyzes the calculated shape-change by means of a predetermined process such as a differential operation, and thereby calculates a first feature amount of the fertile ovum F. The feature amount calculating unit 54 outputs numerical data about the first feature amount to the image-capture controller unit 55, the determining unit 56, the predicting unit 57, the display controller unit 58, and the fertile ovum information database 59.

The numerical data about the first feature amount, which is output to the fertile ovum information database 59, is stored in the fertile ovum information database 59 in association with the first quality data about the fertile ovum F (growth state, number of cells, cell symmetric property, fragment, etc.) having the first feature amount evaluated in the above-mentioned Step S02, and treated as second quality data.

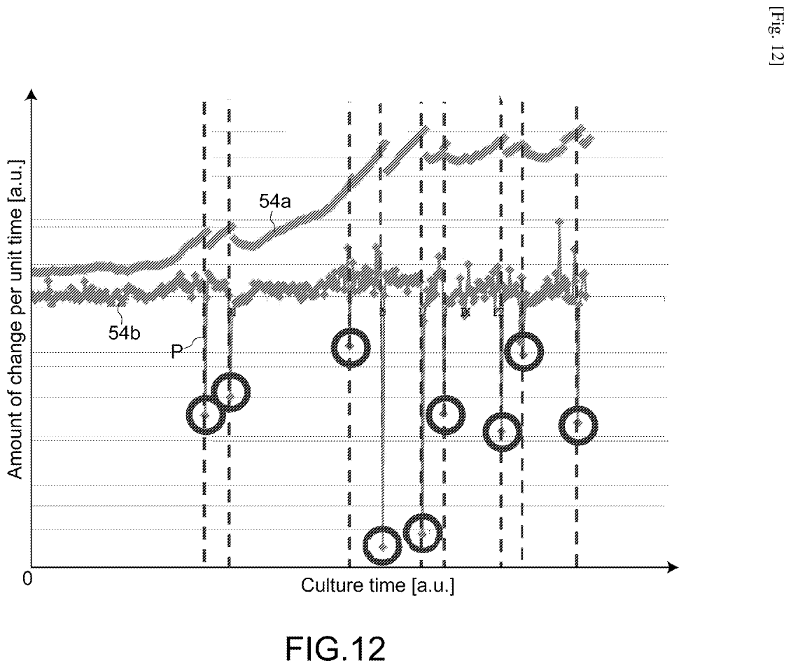

FIG. 12 is a diagram schematically showing the graph 54b, which visualizes the first feature amount calculated by analyzing the shape-change (change of diameter) of the fertile ovum F in time series with reference to the culture time. The feature amount calculating unit 54 is configured to calculate, as the first feature amount, at least one of a number of times of contraction, a contraction diameter, contraction speed, a contraction time period, contraction intervals, contraction strength, and contraction frequency of the fertile ovum F.

Therefore, since they are visualized as shown in the graph of FIG. 12 or the like, a user may quantitatively and objectively confirm minute contract phenomena of the fertile ovum F. With reference to the example of FIG. 12, the shape-change of the fertile ovum F in time series is analyzed to detect the peaks P, and the number of the peaks P corresponds to the number of times of contraction of the fertile ovum F. Note that FIG. 12 shows both the graph 54a, which visualizes the shape-change of the fertile ovum F, and the graph 54b, which visualizes the first feature amount.

Further, in the present technique, where the feature amount calculating unit 54 calculates change of the area of the fertile ovum F in time series as the shape-change, the feature amount calculating unit 54 may calculate the first feature amount on the basis of the difference between the area of the zona pellucida of the fertile ovum F and the area of the inner blastocyst of the fertile ovum F recognized in the above-mentioned Step S03. For example, the number of times that the difference between the area of the zona pellucida and the area of the blastocyst is 0 in the culture time of the fertile ovum F is counted. The number of times that the difference between the area of the zona pellucida and the area of the blastocyst is not 0 in the culture time of the fertile ovum F is counted. As a result, the number of times of contraction of the zona pellucida and the number of times of contraction of the blastocyst are obtained.

(Step S06: Determine Quality)

The determining unit 56 checks the numerical data about the first feature amount output from the feature amount calculating unit 54 against the second quality data corresponding to the first feature amount prestored in the fertile ovum information database 59. As a result, the determining unit 56 determines the quality (growth state, quality rank, etc.) of the fertile ovum F.

Therefore, the determining unit 56 is capable of automatically determining the quality of the fertile ovum F on the basis of the first feature amount output from the feature amount calculating unit 54 by using the quality result determined on the basis of the morphological findings of an embryologist.

At this time, the determining unit 56 selects, as the second quality data corresponding to the numerical data about the first feature amount, the second quality data including the numerical data most similar to the numerical data about the first feature amount. The determining unit 56 retrieves the selected second quality data from the fertile ovum information database 59.

Next, the determining unit 56 outputs the quality result of the fertile ovum F, which is determined by checking the numerical data about the first feature amount against the second quality data, to the display controller unit 58 and the fertile ovum information database 59. As a result, the quality result is stored as new reference data (second quality data) in the fertile ovum information database 59, and the fertile ovum information database 59 is updated.

(Step S07: Calculate Predictive Value)

The predicting unit 57 checks at least one of the numerical data about the shape-change and the numerical data about the first feature amount, which are output from the feature amount calculating unit 54, against the third quality data corresponding thereto (incubation rate, implantation rate, pregnancy rate, conception rate, miscarriage rate, birthweight, birth rate, and breeding value of a grown-up, etc.) prestored in the fertile ovum information database 59. As a result, the predicting unit 57 calculates at least one of an incubation rate, an implantation rate, a pregnancy rate, a conception rate, a miscarriage rate, a birthweight, a birth rate, and a breeding value of a grown-up of the fertile ovum F.

At this time, the predicting unit 57 selects, as the third quality data corresponding to the numerical data about the shape-change and the numerical data about the first feature amount output from the feature amount calculating unit 54, the third quality data about the fertile ovum F having the shape-change and the first feature amount most similar thereto. The predicting unit 57 retrieves the selected third quality data from the fertile ovum information database 59.

Next, the predicting unit 57 outputs the predictive value of the fertile ovum F, which is determined by checking at least one of the numerical data about the shape-change and the numerical data about the first feature amount against the third quality data, to the display controller unit 58 and the fertile ovum information database 59. As a result, the predictive value is stored as new reference data (third quality data) in the fertile ovum information database 59, and the fertile ovum information database 59 is updated.

(Step S08: Display Quality Result)

The display controller unit 58 displays, on the display device 60, a web dashboard indicating the first and second time-series images G1 and G2 (images under observation) obtained from the image obtaining unit 51 and the image processing unit 52, the processed images obtained from the recognizing unit 53 (fertile-ovum-recognized images, motion vector images, heat map image indicating movement amounts, and the like), the transformation and the feature amounts obtained from the feature amount calculating unit 54, the quality result of the fertile ovum F obtained from the determining unit 56, the predictive value obtained from the predicting unit 57, a growth stage code corresponding to a growth stage of the fertile ovum F, alternatively, various images and quality information retrieved from the fertile ovum information database 59, and the like.

As a result, a user may select the fertile ovum F before implantation with a high degree of accuracy comprehensively in view of the images under observation, the fertile-ovum-recognized image, the motion vector image, the heat map image indicating movement amounts, the transformation, the feature amount, the quality result, the predictive value, and the like about the fertile ovum F. Note that the display controller unit 58 may display, on the display device 60, not only the above-mentioned information but also position information of the well W in which the fertile ovum F is held, image-capture date and time, image-capture conditions, and the like.

(Machine Learning Algorithm)

In the present technique, the image processing apparatus 50 executes the above-mentioned steps including Step S02 to Step S07 in accordance with a machine learning algorithm. The machine learning algorithm is not particularly limited. For example, a machine learning algorithm that employs a neural network such as RNN (Recurrent Neural Network), CNN (Convolutional Neural Network), and MLP (Multilayer Perceptron) may be used. Alternatively, an arbitrary machine learning algorithm that executes supervised learning, unsupervised learning, semi-supervised learning, reinforcement learning, or other learning may be used.

(Effects)

In recent years, in the fertility treatment field, the livestock industrial field, and other fields, the quality of a cell (fertile ovum) to be implanted is an important factor that affects implantation results. Typically, a cell to be implanted is selected by determining the growth or quality of a cell on the basis of morphological findings by using an optical microscope, an image processing apparatus, or the like.

However, the above-mentioned morphological evaluation method of evaluating the quality of a fertile ovum before implantation requires a skilled person. In addition, a person tends to be subjective. In view of such circumstances, it is required to provide a method of evaluating the quality of a fertile ovum quantitatively and highly objectively. It is required to provide a method of evaluating the quality of a fertile ovum not only morphologically but also multilaterally.

In view of the above-mentioned circumstances, according to the present embodiment, the image processing apparatus 50 evaluates the quality of the fertile ovum F before implantation by using the quality information, in which the feature amounts based on the shape-change of the fertile ovum F is in association with the quality result of the fertile ovum F obtained on the basis of morphological findings. Therefore the quality of the fertile ovum F may be multilaterally evaluated in view of morphological findings of the fertile ovum F and the shape-change of the fertile ovum F. The fertile ova F under observation may be evaluated with a high degree of accuracy.

Further, according to the present embodiment, the image processing apparatus 50 is capable of automatically calculating the transformation, the feature amounts, and the like about the fertile ovum F on the basis of images of the fertile ovum F. Therefore efficiency of evaluation of the quality of the fertile ovum F multilaterally is greatly increased as compared to evaluation in the past, in which an embryologist confirms images of a fertile ovum F one by one on the basis of his/her morphological findings.

(Modification Examples)

In the first embodiment, the feature amount calculating unit 54 calculates, as the first feature amount, a number of times of contraction, a contraction diameter, contraction speed, a contraction time period, contraction intervals, contraction strength, and contraction frequency of the fertile ovum F. However, other than the above, the feature amount calculating unit 54 may calculate a number of times of dilation, a dilation diameter, dilation speed, a dilation time period, dilation intervals, dilation strength, and dilation frequency resulting from a dilation phenomenon of the fertile ovum F.

Further, in the first embodiment, the determining unit 56 determines the quality of the fertile ovum F on the basis of the numerical data about the first feature amount output from the feature amount calculating unit 54. Not limited to this, for example, the determining unit 56 may determine the quality of the fertile ovum F on the basis of one or both of the numerical data about the shape-change and the numerical data about the first feature amount output from the feature amount calculating unit 54.

### Second Embodiment

Next, with reference to FIG. 7 as necessary, a method of evaluating the quality of the fertile ovum F executed by the image processing apparatus 50 according to a second embodiment of the present technique will be described. The image processing apparatus 50 of the present embodiment is capable of executing the following steps in addition to the above-mentioned evaluation method of the first embodiment. Note that description of steps similar to the steps of the first embodiment will be omitted.

(Quality Evaluation)

(Step S03: Image Processing)

The recognizing unit 53 processes the plurality of second time-series images G2 obtained from the image processing unit 52 in a predetermined way. The recognizing unit 53 outputs the plurality of second time-series images G2 having been processed to the feature amount calculating unit 54 and the fertile ovum information database 59. The fertile ovum information database 59 stores the plurality of second time-series images G2 having been processed.

For example, the recognizing unit 53 is configured to form mask areas for the plurality of second time-series images G2, respectively, each of the mask areas being along a shape of each of the fertile ova F. As a result, the analysis area (recognition area) of the fertile ovum F of each of the second time-series images G2 is clarified, and the position of the fertile ovum F in the well W may be recognized accurately.

(Step S04: Calculate Transformation)

The feature amount calculating unit 54 analyzes the plurality of second time-series images G2 output from the recognizing unit 53 in a predetermined way, and thereby calculates time-series change of a relative position of the fertile ovum F relative to the well W, the fertile ovum being held in the well W. The feature amount calculating unit 54 outputs numerical data about the change of a relative position to the image-capture controller unit 55, the determining unit 56, the predicting unit 57, the display controller unit 58, and the fertile ovum information database 59. The fertile ovum information database 59 stores the numerical data output from the feature amount calculating unit 54 as reference data in the fertile ovum information database 59.

The feature amount calculating unit 54 calculates a differential value between the mask area of one second time-series image and the mask area of another second time-series image of the plurality of mask areas formed on the plurality of second time-series images G2 in the above-mentioned Step S03. In other words, the feature amount calculating unit 54 calculates inter-frame differential values of only the mask areas along the shapes of the fertile ova F, and calculates the change of a relative position on the basis of the differential value.

As a result, occurrence of noises and mis-detection, which results from an interframe differential value calculated on the basis of the whole second time-series images G2, is reduced. The change of a relative position relative to the well W and a second feature amount (described later) of the fertile ovum F may be calculated accurately.

In the present embodiment, the feature amount calculating unit 54 calculates, as the change of a relative position, time-series change of the position of the fertile ovum F in the well W in the X-axis direction (change of X coordinate position) and time-series change of the position of the fertile ovum F in the well W in the Y-axis direction (change of Y coordinate position). Therefore, since they are visualized in a graph or the like, a user may confirm the time-series change of a relative position of the fertile ovum F relative to the well W.

(Step 505: Calculate Feature Amount)

Subsequently, the feature amount calculating unit 54 analyzes the calculated change of a relative position by means of a predetermined process, and thereby calculates a second feature amount of the fertile ovum F. The feature amount calculating unit 54 outputs numerical data about the second feature amount to the image-capture controller unit 55, the determining unit 56, the predicting unit 57, the display controller unit 58, and the fertile ovum information database 59.

The numerical data about the second feature amount, which is output to the fertile ovum information database 59, is stored in the fertile ovum information database 59 in association with the second quality data prestored in the fertile ovum information database 59 (quality data in which numerical data about the first feature amount is in association with first quality data), and treated as fourth quality data.

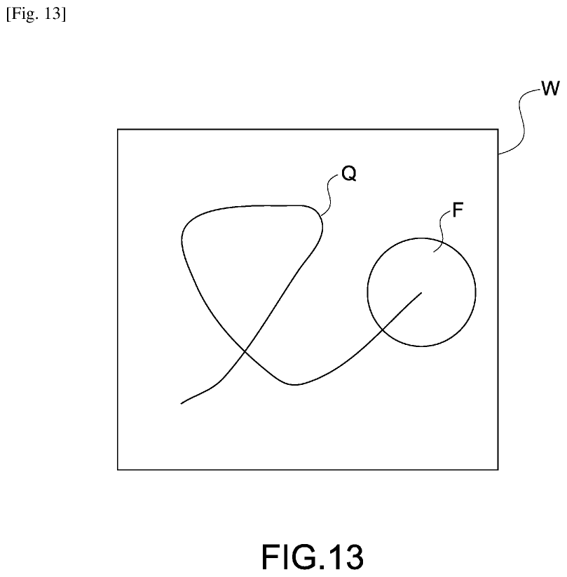

FIG. 13 is a diagram, which visualizes the second feature amount (movement locus) calculated by analyzing the change of a relative position of the fertile ovum F held in the well W in time series. The feature amount calculating unit 54 is configured to calculate, as the second feature amount, at least one of a central coordinate, a movement amount, a motion amount, a movement distance (length of locus), movement speed, movement acceleration, and a movement locus of the fertile ovum F. Therefore, since they are visualized as shown in the graph of FIG. 13 or the like, a user may confirm the motion ability of the fertile ovum F in the well W. Note that, in the example of FIG. 13, the curved line Q corresponds to the movement locus of the fertile ovum F in the well W.

(Step S06: Determine Quality)

The determining unit 56 checks at least one of the numerical data about the first feature amount and the numerical data about the second feature amount output from the feature amount calculating unit 54 against the fourth quality data corresponding thereto prestored in the fertile ovum information database 59. As a result, the determining unit 56 determines the quality (growth state, quality rank, etc.) of the fertile ovum F.

At this time, the determining unit 56 selects, as the fourth quality data corresponding to the numerical data about the first and second feature amounts output from the feature amount calculating unit 54, the fourth quality data about the fertile ovum F having the first and second feature amounts most similar thereto. The determining unit 56 retrieves the selected fourth quality data from the fertile ovum information database 59.

As a result, the determining unit 56 is capable of automatically evaluating the quality comprehensively in view of morphological findings of the fertile ovum F, shape-change of the fertile ovum F in time series, and change of a relative position in the well W. The determining unit 56 is capable of evaluating the fertile ovum F under observation with a high degree of accuracy.

Next, the determining unit 56 outputs the quality result of the fertile ovum F, which is determined by checking at least one of the numerical data about the first feature amount and the numerical data about the second feature amount against the fourth quality data, to the display controller unit 58 and the fertile ovum information database 59. As a result, the quality result is stored as new reference data (fourth quality data) in the fertile ovum information database 59, and the fertile ovum information database 59 is updated.

(Step S07: Calculate Predictive Value)

The predicting unit 57 checks the numerical data about at least one of the shape-change, first feature amount, and the second feature amount, which is output from the feature amount calculating unit 54, against the third quality data corresponding thereto (incubation rate, implantation rate, pregnancy rate, conception rate, miscarriage rate, birthweight, birth rate, and breeding value of a grown-up, etc.) prestored in the fertile ovum information database 59. As a result, the predicting unit 57 calculates at least one of an incubation rate, an implantation rate, a pregnancy rate, a conception rate, a miscarriage rate, a birthweight, a birth rate, and a breeding value of a grown-up of the fertile ovum F.

At this time, the predicting unit 57 selects, as the third quality data corresponding to the numerical data about the shape-change, the first feature amount, and the second feature amount output from the feature amount calculating unit 54, the third quality data about the fertile ovum F having the shape-change, the first feature amount, and the second feature amount most similar thereto. The predicting unit 57 retrieves the selected third quality data from the fertile ovum information database 59.

Next, the predicting unit 57 outputs the predictive value of the fertile ovum F, which is determined by checking the numerical data about at least one of the shape-change, first feature amount, and the second feature amount against the third quality data, to the display controller unit 58 and the fertile ovum information database 59. As a result, the predictive value is stored as new reference data (third quality data) in the fertile ovum information database 59, and the fertile ovum information database 59 is updated.

(Modification Examples)

In the second embodiment, the determining unit 56 determines the quality of the fertile ovum F on the basis of the numerical data about at least one of the first and second feature amounts output from the feature amount calculating unit 54. Not limited to this, for example, the determining unit 56 may determine the quality of the fertile ovum F on the basis of one or all of the numerical data about the shape-change, the numerical data about change of a relative position, the numerical data about the first feature amount, and the numerical data about the second feature amount output from the feature amount calculating unit 54.

Further, in the second embodiment, the determining unit 56 checks at least one of the numerical data about the first feature amount and the numerical data about the second feature amount against the fourth quality data, and thereby determines the quality of the fertile ovum F. Not limited to this, the second quality data may be used alternatively.

### Third Embodiment

Next, with reference to FIG. 7 as necessary, a method of evaluating the quality of the fertile ovum F executed by the image processing apparatus 50 according to a third embodiment of the present technique will be described. The image processing apparatus 50 of the present embodiment is capable of executing the following steps in addition to the above-mentioned evaluation method of the first and second embodiments. Note that description of steps similar to the steps of the first and second embodiments will be omitted.

(Quality Evaluation)

(Step S03: Image Processing)

The recognizing unit 53 processes the plurality of second time-series images G2 obtained from the image processing unit 52 in a predetermined way. The recognizing unit 53 outputs the plurality of second time-series images G2 having been processed to the feature amount calculating unit 54 and the fertile ovum information database 59. The fertile ovum information database 59 stores the plurality of second time-series images G2 having been processed.

For example, the recognizing unit 53 is configured to form mask areas for the plurality of second time-series images G2, respectively, each of the mask areas being along a shape of each of the fertile ova F. As a result, the analysis area (recognition area) of the fertile ovum F of each of the second time-series images G2 is clarified, and the shapes of the cells in the fertile ovum F may be recognized accurately.

(Step S04: Calculate Transformation)

The feature amount calculating unit 54 analyzes the plurality of second time-series images G2 output from the recognizing unit 53 in a predetermined way, and thereby calculates time-series change of a macroscopic inner movement amount of the fertile ovum F. The feature amount calculating unit 54 outputs numerical data about the movement amount to the image-capture controller unit 55, the determining unit 56, the predicting unit 57, the display controller unit 58, and the fertile ovum information database 59.

The feature amount calculating unit 54 calculates a differential value between the mask area of one second time-series image and the mask area of another second time-series image of the plurality of mask areas formed on the plurality of second time-series images G2 in the above-mentioned Step S03. In other words, the feature amount calculating unit 54 calculates inter-frame differential values of only the mask areas along the shapes of the fertile ova F, and calculates the change of the movement amount.

As a result, occurrence of noises and mis-detection, which results from an inter-frame differential value calculated on the basis of the whole second time-series images G2, is reduced. The change of an inner movement amount of the fertile ovum F may be calculated accurately.

The numerical data about the change of a movement amount, which is output to the fertile ovum information database 59, is stored in the fertile ovum information database 59 in association with the fourth quality data prestored in the fertile ovum information database 59 (quality data in which numerical data about the first feature amount, numerical data about the second feature amount, and first quality data are in association with each other), and treated as fifth quality data.

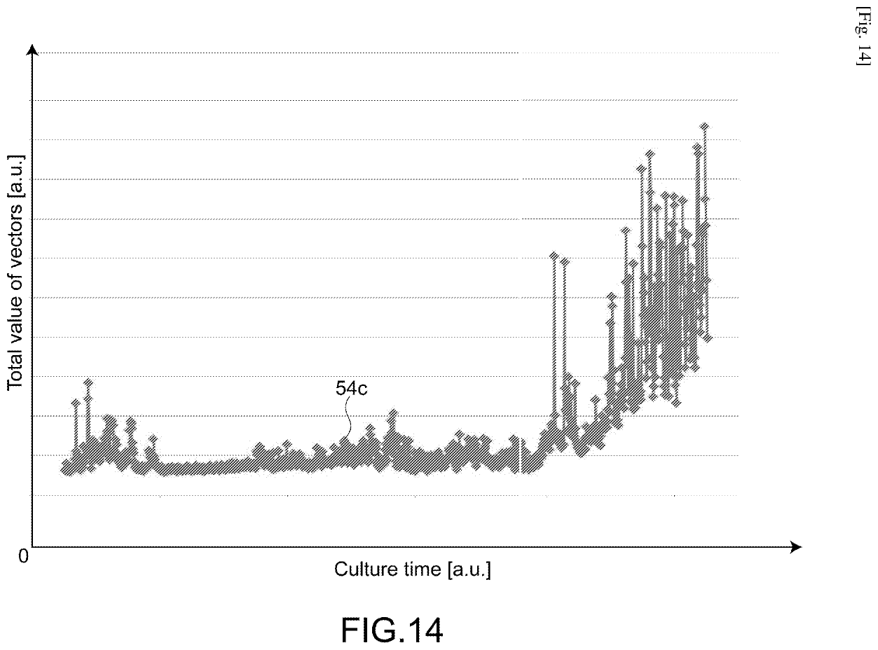

FIG. 14 is a diagram schematically showing the the graph 54c, which visualizes the change of a movement amount of the cells inside the fertile ovum F (total value of speed vector) with reference to the culture time. The feature amount calculating unit 54 calculates, as the change of the movement amount, time-series change of at least one of the minimum speed of motion vectors of the cells, the maximum speed, the maximum acceleration, the average speed, the average acceleration, the median value, the standard deviation, the total value of speed vectors, and the total value of acceleration vectors. Therefore, since they are visualized as shown in the graph of FIG. 14 or the like, it is possible to evaluate the motion ability of the inside of the fertile ovum F where the outline of the fertile ovum F less changes.

(Step S06: Determine Quality)

The determining unit 56 checks the numerical data about at least one of the first feature amount, the second feature amount, and the time-series change of the inner movement amount of the fertile ovum F output from the feature amount calculating unit 54 against the fifth quality data corresponding thereto prestored in the fertile ovum information database 59. As a result, the determining unit 56 determines the quality (growth state, quality rank, etc.) of the fertile ovum F.

At this time, the determining unit 56 selects, as the fifth quality data corresponding to the numerical data about the first feature amount, the second feature amount, and the change of the movement amount output from the feature amount calculating unit 54, the fifth quality data about the fertile ovum F having the first feature amount, the second feature amount, and the change of the movement amount most similar thereto. The determining unit 56 retrieves the selected fifth quality data from the fertile ovum information database 59.

As a result, the determining unit 56 is capable of automatically evaluating the quality comprehensively in view of morphological findings of the fertile ovum F, shape-change of the fertile ovum F in time series, time-series change of a relative position in the well W, and time-series change of an inner movement amount of cells. The determining unit 56 is capable of evaluating the fertile ovum F under observation with a high degree of accuracy.

Next, the determining unit 56 outputs the quality result of the fertile ovum F, which is determined by checking the numerical data about at least one of the first feature amount, the second feature amount, and the time-series change of the inner movement amount of the fertile ovum F against the fifth quality data, to the display controller unit 58 and the fertile ovum information database 59. As a result, the quality result is stored as new reference data (fifth quality data) in the fertile ovum information database 59, and the fertile ovum information database 59 is updated.

(Step S07: Calculate Predictive Value)

The predicting unit 57 checks the numerical data about at least one of the shape-change, the first feature amount, the second feature amount, and the time-series change of the inner movement amount of the fertile ovum F, which is output from the feature amount calculating unit 54, against the third quality data corresponding thereto (incubation rate, implantation rate, pregnancy rate, conception rate, miscarriage rate, birthweight, birth rate, and breeding value of a grown-up, etc.) prestored in the fertile ovum information database 59. As a result, the predicting unit 57 calculates at least one of an incubation rate, an implantation rate, a pregnancy rate, a conception rate, a miscarriage rate, a birthweight, a birth rate, and a breeding value of a grown-up of the fertile ovum F.

At this time, the predicting unit 57 selects, as the third quality data corresponding to the numerical data about at least one of the shape-change, the first feature amount, the second feature amount, and the change of the movement amount output from the feature amount calculating unit 54, the third quality data about the fertile ovum F having the shape-change, the first feature amount, the second feature amount, and the change of the movement amount most similar thereto. The predicting unit 57 retrieves the selected third quality data from the fertile ovum information database 59.

Next, the predicting unit 57 outputs the predictive value of the fertile ovum F, which is determined by checking the numerical data about at least one of the shape-change, the first feature amount, the second feature amount, and the change of the movement amount against the third quality data, to the display controller unit 58 and the fertile ovum information database 59. As a result, the predictive value is stored as new reference data (third quality data) in the fertile ovum information database 59, and the fertile ovum information database 59 is updated.

(Modification Examples)

In the third embodiment, the determining unit 56 determines the quality of the fertile ovum F on the basis of the numerical data about at least one of the first feature amount, the second feature amount, and the change of the movement amount output from the feature amount calculating unit 54. Not limited to this, for example, the determining unit 56 may determine the quality of the fertile ovum F on the basis of one or all of the numerical data about the shape-change, the numerical data about change of a relative position, the numerical data about the first feature amount, the numerical data about the second feature amount, and the numerical data about the change of the movement amount output from the feature amount calculating unit 54.

Further, in the third embodiment, the determining unit 56 checks the numerical data about at least one of the first feature amount, the second feature amount, and the time-series change of the inner movement amount of the fertile ovum F against the fifth quality data, and thereby determines the quality of the fertile ovum F. Not limited to this, the second quality data or the fourth quality data may be used alternatively.

### Fourth Embodiment

Next, with reference to FIG. 7 as necessary, a method of evaluating the quality of the fertile ovum F executed by the image processing apparatus 50 according to a fourth embodiment of the present technique will be described. The image processing apparatus 50 of the present embodiment is capable of executing the following steps in addition to the above-mentioned evaluation method of the first to third embodiments.

Note that description of steps similar to the steps of the first to third embodiments will be omitted.

(Quality Evaluation)

(Step S05: Calculate Feature Amount)

The image obtaining unit 51 obtains the plurality of first time-series images G1 transferred from the image-capture unit 21, and outputs the plurality of first time-series images G1 to the feature amount calculating unit 54. The feature amount calculating unit 54 analyzes the plurality of first time-series images G1 obtained from the image obtaining unit 51 by means of a predetermined process, and thereby calculates a third feature amount of the fertile ovum F. The feature amount calculating unit 54 outputs numerical data about the third feature amount to the image-capture controller unit 55, the determining unit 56, the predicting unit 57, and the fertile ovum information database 59.

The numerical data about the third feature amount, which is output to the fertile ovum information database 59, is stored in the fertile ovum information database 59 in association with the fifth quality data prestored in the fertile ovum information database 59 (quality data in which numerical data about the first feature amount, numerical data about the second feature amount, first quality data, and numerical data about the time-series change of the inner movement amount of the fertile ovum F are in association with each other), and treated as sixth quality data.

In the present embodiment, the third feature amount is information about a characteristic part of images, which is calculated on the basis of the images of the fertile ovum F under observation. The third feature amount includes, for example, size, shape, sphericity, and cell-division number (rate) of a fertile ovum, forms of daughter cells, symmetric property of the daughter cells, fragmentation, original size and shape of ICM (described later), and the like. The third feature amount is calculated on the basis of various growth stages of the fertile ovum F.

(Step S06: Determine Quality)

The determining unit 56 checks the numerical data about at least one of the first to third feature amounts and the time-series change of the inner movement amount of the fertile ovum F output from the feature amount calculating unit 54 against the sixth quality data corresponding thereto prestored in the fertile ovum information database 59. As a result, the determining unit 56 determines the quality and growth stage of the fertile ovum F. A growth stage code is given to the fertile ovum F depending on its growth stage.

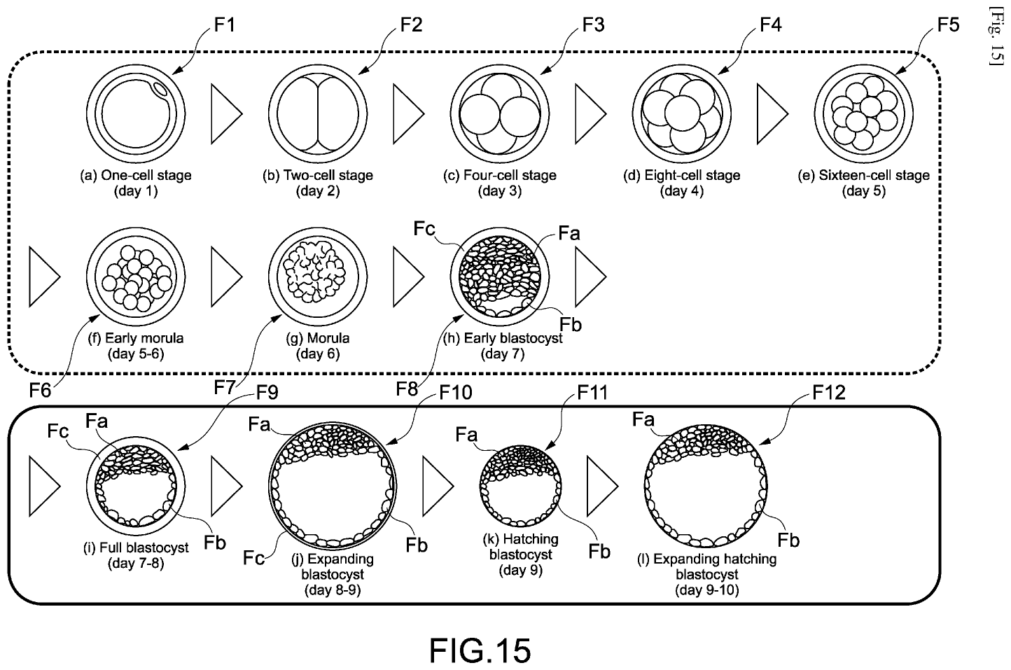

In the present embodiment, growth stage codes are given to images of the fertile ovum F depending on growth stages of the fertile ovum F. For example, a growth stage code 1 indicates the growth stage of a one-cell stage F1, a growth stage code 2 indicates the growth stage of a two-cell stage F2 to a sixteen-cell stage F5, a growth stage code 3 indicates the growth stage of an early morula F6, a growth stage code 4 indicates the growth stage of a morula F7, a growth stage code 5 indicates the growth stage of an early blastocyst F8, a growth stage code 6 indicates the growth stage of a full blastocyst F9, a growth stage code 7 indicates the growth stage of an expanding blastocyst F10, a growth stage code 8 indicates the growth stage of a hatching blastocyst F11, and a growth stage code 9 indicates the growth stage of an expanding hatching blastocyst F12 (see FIG. 15).

At this time, the determining unit 56 selects, as the sixth quality data corresponding to the numerical data about the first to third feature amounts and the change of the movement amount output from the feature amount calculating unit 54, the sixth quality data about the fertile ovum F having the first to third feature amounts and the change of the movement amount most similar thereto. The determining unit 56 retrieves the selected sixth quality data from the fertile ovum information database 59.

As a result, the determining unit 56 is capable of automatically evaluating the quality comprehensively in view of morphological findings of the fertile ovum F, shape-change of the fertile ovum F in time series, time-series change of a relative position in the well W, time-series change of an inner movement amount of cells, and a growth stage. The determining unit 56 is capable of evaluating the fertile ovum F under observation with a high degree of accuracy.

Next, the determining unit 56 outputs the quality result of the fertile ovum F, which is determined by checking the numerical data about at least one of the first to third feature amounts and the change of the movement amount against the sixth quality data, to the display controller unit 58 and the fertile ovum information database 59. As a result, the quality result is stored as new reference data (sixth quality data) in the fertile ovum information database 59, and the fertile ovum information database 59 is updated.

(Step S07: Calculate Predictive Value)

The predicting unit 57 checks the numerical data about at least one of the shape-change, the first to third feature amounts, and the change of the movement amount, which is output from the feature amount calculating unit 54, against the third quality data corresponding thereto (incubation rate, implantation rate, pregnancy rate, conception rate, miscarriage rate, birthweight, birth rate, and breeding value of a grown-up, etc.) prestored in the fertile ovum information database 59. As a result, the predicting unit 57 calculates at least one of an incubation rate, an implantation rate, a pregnancy rate, a conception rate, a miscarriage rate, a birthweight, a birth rate, and a breeding value of a grown-up of the fertile ovum F.

At this time, the predicting unit 57 selects, as the third quality data corresponding to the numerical data about at least one of the shape-change, the first to third feature amounts, and the change of the movement amount output from the feature amount calculating unit 54, the third quality data about the fertile ovum F having the shape-change, the first feature amount, the second feature amount, the third feature amount, and the change of the movement amount most similar thereto. The predicting unit 57 retrieves the selected third quality data from the fertile ovum information database 59.

Next, the predicting unit 57 outputs the predictive value of the fertile ovum F, which is determined by checking the numerical data about at least one of the shape-change, the first to third feature amounts, and the change of the movement amount against the third quality data, to the display controller unit 58 and the fertile ovum information database 59. As a result, the predictive value is stored as new reference data (third quality data) in the fertile ovum information database 59, and the fertile ovum information database 59 is updated.

(Modification Examples)

In the fourth embodiment, the determining unit 56 determines the quality of the fertile ovum F on the basis of at least one of the numerical data about the first feature amount, the numerical data about the second feature amount, the numerical data about the third feature amount, and the numerical data about the change of the movement amount output from the feature amount calculating unit 54. Not limited to this, for example, the determining unit 56 may determine the quality of the fertile ovum F on the basis of one or all of the numerical data about the shape-change, the numerical data about change of a relative position, the numerical data about the first to third feature amounts, and the numerical data about the change of the movement amount output from the feature amount calculating unit 54.

Further, in the fourth embodiment, the determining unit 56 checks at least one of the numerical data about the first to third feature amounts and the numerical data about the time-series change of the inner movement amount of the fertile ovum F against the sixth quality data, and thereby determines the quality of the fertile ovum F. Not limited to this, the second quality data, the fourth quality data, or the fifth quality data may be used alternatively.

### Fifth Embodiment

Next, a method of evaluating the quality of the fertile ovum F executed by the image processing apparatus 50 according to a fifth embodiment of the present technique will be described. Before describing an evaluation method of the present embodiment, the shape-change of a fertile ovum depending on its growth will be described with reference to FIG. 15 firstly.

FIG. 15 shows typical growth stages of a fertile ovum from one day after fertilization to ten days after fertilization. (a) of FIG. 15 shows a one-cell stage fertile ovum F1 on the first day that fertilization is confirmed. (b) of FIG. 15 shows a two-division fertile ovum, i.e., a two-cell stage fertile ovum F2 on the second day of fertilization.

After that, when the fertile ovum F grows without a problem, the number of cells of the fertile ovum F increases in order. (c) of FIG. 15 shows a four-cell stage fertile ovum F3 on the third day of fertilization, (d) of FIG. 15 shows an eight-cell stage fertile ovum F4 on the fourth day of fertilization, and (e) of FIG. 15 shows a sixteen-cell stage fertile ovum F5 on the fifth day of fertilization.

After that, cells come close together. (f) of FIG. 15 shows an early morula F6 on the fifth to sixth day of fertilization. (g) of FIG. 15 shows a morula F7 on the sixth day of fertilization. When the fertile ovum F grows further, a cavity in a cytoplasm is generated to form a blastocoel. (h) of FIG. 15 shows an early blastocyst F8 on the seventh day of fertilization.

(i) of FIG. 15 shows a full blastocyst F9, which has an enlarged blastocoel, on the seventh to eighth day of fertilization. In the blastocyst growth stage (F8 and thereafter), it is possible to distinguish between an inner cell mass Fa (hereinafter, referred to as ICM.), which is to be a fetus, and a trophectoderm Fb.

In the growth stage of an early blastocyst F8 and a full blastocyst F9, a zona pellucida Fc, which forms the outline of the fertile ovum, is recognized. Further, the zona pellucida Fc gets thinner. The fertile ovum becomes an expanding blastocyst F10 on the eighth to ninth day of fertilization. A blastocyst hatches off a zona pellucida to be a hatching blastocyst F11 on the ninth day of fertilization. An expanding hatching blastocyst F12 appears on the ninth to tenth day of fertilization.

In general, there is known a lag-phase, in which dynamic increase of cells is suspended, in the above-mentioned growth process of a fertile ovum. By the way, in recent years, it is known that a lag-phase appears in the division process from the four-cell stage (F3) to the eight-cell stage (F4). It is also known that a fertile ovum, which has a larger number of cells at the start of the lag-phase, an earlier start time of the lag-phase, and a shorter time period of the lag-phase, has a higher genesis ability (pregnancy rate, etc.) after implantation. (See http://www.naro.affrc.go.jp/project/results/laboratory/niah/1999/niah99-021.html)

In view of the above-mentioned circumstances, in the fertility treatment field, the livestock industrial field, and other fields, people pay attention to the lag-phase of a fertile ovum since it is an important indicator to distinguish a fertile ovum having a high genesis ability from other fertile ova.

In view of the above, in the fifth embodiment of the present technique, with reference to FIG. 7 as necessary, a method of determining a lag-phase of the fertile ovum F and predicting a genesis ability of the fertile ovum F after implantation on the basis of the lag-phase will be described. The image processing apparatus 50 of the present embodiment is capable of executing the following steps in addition to the above-mentioned evaluation method of the first to fourth embodiments. Note that description of steps similar to the steps of the first to fourth embodiments will be omitted.

(Quality Evaluation)

(Step S06: Determine Quality)

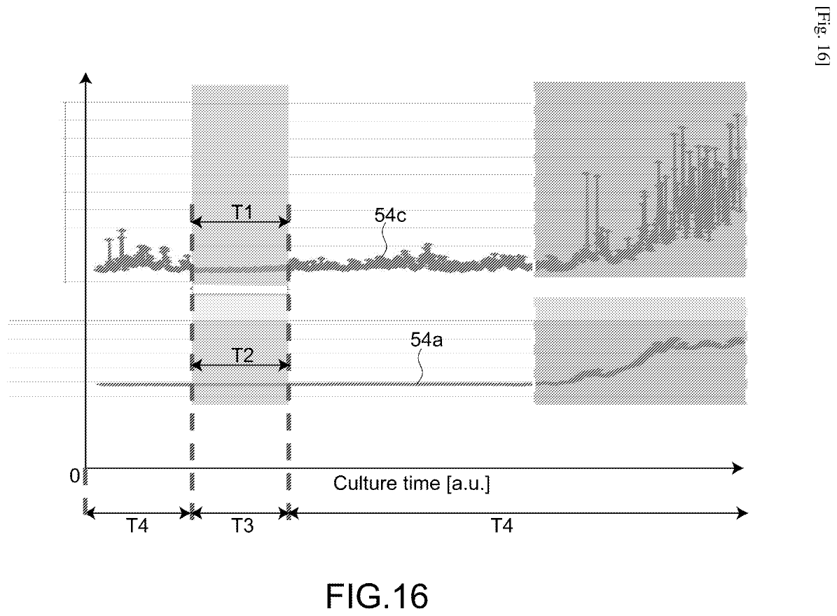

FIG. 16 is a diagram showing both the graph 54a, which visualizes shape-change of the fertile ovum F in time series with reference to the culture time (change of diameter), and the graph 54c, which visualizes change of the movement amount of cells inside the fertile ovum F (total value of speed vectors).

The determining unit 56 retrieves numerical data about the total value of time-series speed vectors (see third embodiment) of the fertile ovum F stored in the fertile ovum information database 59 from the fertile ovum information database 59. The determining unit 56 analyzes the numerical data by means of a predetermined process, and thereby detects the first time period T1, in which change of the total value of time-series speed vectors per unit culture time is approximately zero.

Next, the determining unit 56 retrieves numerical data about the change of the diameter (see the first embodiment) of the fertile ovum F, whose first time period T1 is detected, from the fertile ovum information database 59. The determining unit 56 analyzes the numerical data by means of a predetermined process, and thereby detects the second time period T2, in which time-series change of the diameter per unit culture time is approximately zero.

Subsequently, the determining unit 56 determines the lag-phase period T3 (inactive period) of the fertile ovum F, whose first and second time periods T1 and T2 are detected, on the basis of the first and second time periods T1 and T2. In other words, the determining unit 56 determines the culture time period of the fertile ovum F including both the first time period T1 and the second time period T2 as the lag-phase period T3 of the fertile ovum F.

Next, the determining unit 56 generates seventh quality data, in which numerical data about change of the diameter of the fertile ovum F in the lag-phase period T3 is in association with the first quality data (growth state, number of cells, elapsed time of culturing, etc.) of the fertile ovum F in the lag-phase period T3 corresponding to the numerical data evaluated in the above-mentioned Step S02.

Next, the determining unit 56 outputs the seventh quality data, in which the numerical data about change of the diameter of the fertile ovum F in the lag-phase period T3 is in association with the first quality data of the fertile ovum F in the lag-phase period T3, to the predicting unit 57 and the fertile ovum information database 59. The seventh quality data output to the fertile ovum information database 59 is stored as reference data in the fertile ovum information database 59.

(Step S07: Calculate Predictive Value)

The predicting unit 57 checks the seventh quality data output from the determining unit 56 against the third quality data corresponding to the seventh quality data (incubation rate, implantation rate, pregnancy rate, conception rate, miscarriage rate, birthweight, birth rate, and breeding value of a grown-up, etc.) prestored in the fertile ovum information database 59. As a result, the predicting unit 57 calculates at least one of an incubation rate, an implantation rate, a pregnancy rate, a conception rate, a miscarriage rate, a birthweight, a birth rate, and a breeding value of a grown-up of the fertile ovum F.

At this time, the predicting unit 57 selects, as the third quality data corresponding to the seventh quality data (diameter, growth state, number of cells, and elapsed time of culturing of the fertile ovum F in the lag-phase period T3), the third quality data about the fertile ovum F having the diameter, growth state, number of cells, elapsed time of culturing most similar thereto. The predicting unit 57 retrieves the selected third quality data from the fertile ovum information database 59.

Next, the predicting unit 57 outputs the predictive value of the fertile ovum F, which is determined by checking the seventh quality data against the third quality data, to the display controller unit 58 and the fertile ovum information database 59. As a result, the predictive value is stored as new reference data (third quality data) in the fertile ovum information database 59, and the fertile ovum information database 59 is updated.

(Effects)

According to the fifth embodiment, the image processing apparatus 50 is capable of automatically calculating the lag-phase period T3 of the fertile ovum F and a predictive value based on the lag-phase period T3. As a result, efficiency of selecting operation of the fertile ovum F, which is predicted to have a high genesis ability after implantation, is increased significantly.

(Modification Examples)

In the fifth embodiment, the determining unit 56 determines the lag-phase period T3 of the fertile ovum F on the basis of the first and second time periods T1 and T2. Not limited to this, for example, the determining unit 56 may determine one or both of the lag-phase period T3 of the fertile ovum F and the active period T4 other than the lag-phase period T3 on the basis of the first and second time periods T1 and T2.

In this case, the determining unit 56 may calculate a predictive value (incubation rate, implantation rate, pregnancy rate, conception rate, miscarriage rate, birthweight, birth rate, and breeding value of a grown-up, etc.) about the fertile ovum F by means of a method similar to the above-mentioned quality evaluation method on the basis of one or both of the lag-phase period T3 and the active period T4 and on the basis of the first quality data about the fertile ovum F in those time periods. Alternatively, the lag-phase period T3 of the fertile ovum F may be determined on the basis of one of the first and second time periods T1 and T2.

Further, in the fifth embodiment, the determining unit 56 detects the first time period T1 on the basis of numerical data about time-series change of the total value of speed vectors of the fertile ovum F. Not limited to this, the determining unit 56 may detect the first time period T1 on the basis of numerical data about time-series change of the minimum speed, the maximum speed, the maximum acceleration, the average speed, the average acceleration, the median value, the standard deviation, and the total value of acceleration vectors (see third embodiment) other than the time-series change of the total value of speed vectors of the fertile ovum F.

Further, in the fifth embodiment, the determining unit 56 detects the second time period T2 on the basis of numerical data about change of the diameter of the fertile ovum F. Not limited to this, the determining unit 56 may detect the second time period T2 on the basis of numerical data about time-series change of an area, a volume, or roundness (see the first embodiment) other than numerical data about time-series change of the diameter of the fertile ovum F.

### Sixth Embodiment

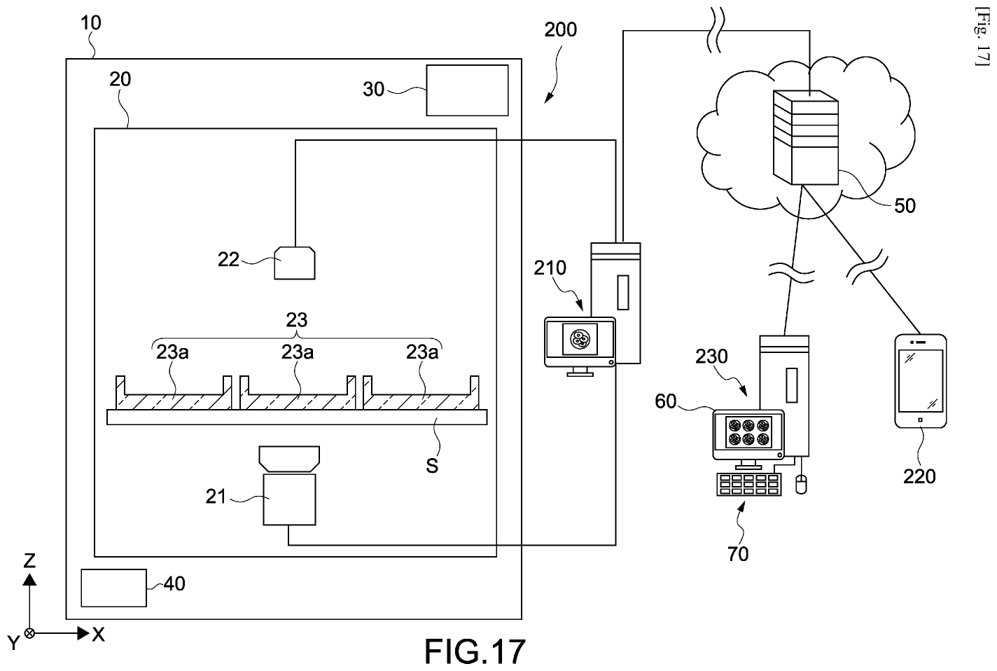

Next, an observation system 200 according to a sixth embodiment of the present technique will be described. FIG. 17 is a diagram schematically showing a configuration example of the observation system 200 according to a sixth embodiment of the present technique. Hereinafter, configuration similar to the configuration of the first embodiment will be denoted by similar reference signs, and detailed description thereof will be omitted.

The observation system 200 of the sixth embodiment includes the observation device 20 including the image-capture unit 21 that captures images of the fertile ova F, and a cloud side via a network that processes and stores capture images and analyzes quality of the fertile ova F by means of machine learning, the cloud side being different from the site of the observation device 20. In other words, the image processing apparatus 50 of the present embodiment is configured to function as a cloud server.

As shown in FIG. 17, the observation system 200 includes the incubator 10, the observation device 20, the humidity-temperature-gas controller unit 30, the detector unit 40, the image processing apparatus 50, and the gateway terminal PC 210. The image processing apparatus 50 of the present embodiment is connected to the gateway terminal PC 210 via a network. Further, the mobile terminal 220 and the PC 230 are connected to the image processing apparatus 50 via the network.

The gateway terminal PC 210 is connected to the observation device 20. The gateway terminal PC 210 receives the plurality of first and second time-series images G1 and G2 from the image-capture unit 21, and outputs the images to the image processing apparatus 50 via the network. Further, the gateway terminal PC 210 stores the plurality of first and second time-series images G1 and G2. In response to operations input by a user, the gateway terminal PC 210 receives the plurality of first and second time-series images G1 and G2 from the image processing apparatus 50 via the network, and displays the plurality of first and second time-series images G1 and G2.

### Other Embodiments

In the present technique, in order for the feature amount calculating unit 54 to calculate time-series change of an area of the fertile ovum F as shape-change, the feature amount calculating unit 54 may be configured to calculate at least one of an area of a zona pellucida, an area of inner daughter cells, an area of an inner morula, and an area of an inner blastocyst of the fertile ovum F.

In this case, the determining unit 56 may be configured to determine compaction (state where divided cells bind firmly together to form a single mass) of the fertile ovum on the basis of change of a differential or a ratio of at least one of an area of a zona pellucida, an area of inner daughter cells, an area of an inner morula, and an area of an inner blastocyst of the fertile ovum F.

Alternatively, the determining unit 56 may be configured to determine cell-division time, a number of daughter cells, a symmetric property of daughter cells, or fragmentation of daughter cells of the fertile ovum on the basis of change of a differential or a ratio of at least one of an area of a zona pellucida and an area of inner daughter cells of the fertile ovum F.

Embodiments of the present technique have been described above. However, the present technique is not limited to the above-mentioned embodiments.

For example, the observation system 100 or 200 repeats Step S01 at arbitrary intervals (for example, every predetermined time such as every 15 minutes or every 24 hours) or without interruption, and evaluates the quality of the fertile ovum F on the basis of images obtained in this step. Not limited to this, the observation system 100 or 200 of the present embodiment may obtain real-time images as necessary, and display the images of the fertile ovum F the display device 60 to observe and evaluate the fertile ovum F as appropriate.

Further, according to the observation system 100 or 200 of the present technique, typically, the fertile ova F under observation are derived from cattle. Not limited to this, they may be derived from livestock such as, for example, mice, pigs, dogs, and cats, or may be derived from human.

Further, in the present description the term “fertile ovum” at least conceptually includes a single cell and a mass of a plurality of cells.

In addition, the present technology is applicable to arbitrary cells such as unfertilized egg cells (ova), embryos, and the like of animals in the livestock industrial field and other fields, and arbitrary cells such as biological samples obtained from living bodies such as stem cells, immune cells, and cancer cells in the regenerative medical field, the pathobiological field, and other field. Further, in the present specification, a “cell” (singular) at least conceptually includes an individual cell and an aggregate of a plurality of cells. One or more “cells” as referred to herein relates to cells observed in one or more stages of embryonic development including, but not limited to, an oocyte, an egg (ovum), a fertile ovum (zygote), a blastocyst, and an embryo.

Note that the present technique may employ the following configurations.

(1)

An image processing apparatus, including:

an image obtaining unit configured to obtain a plurality of images of a fertile ovum captured in time series;

a recognizing unit configured to recognize at least one of a shape of the fertile ovum and a position of the fertile ovum in a well on the basis of the images; and

a feature amount calculating unit configured to

calculate at least one of time-series transformation of the fertile ovum and time-series change of a relative position of the fertile ovum relative to the well, the fertile ovum being held in the well, and

calculate at least one of a first feature amount based on the transformation and a second feature amount based on the change of the relative position.

(2)

The image processing apparatus according to the above-mentioned (1), in which

the feature amount calculating unit is configured to calculate, as the transformation, shape-change of the fertile ovum.

(3)

The image processing apparatus according to the above-mentioned (2), in which

the feature amount calculating unit is configured to calculate, as the shape-change, change of at least one of a diameter, an area, a volume, and roundness of the fertile ovum.

(4)

The image processing apparatus according to any one of the above-mentioned (1) to (3), in which

the feature amount calculating unit is configured to calculate, as the first feature amount, at least one of a number of times of contraction, a contraction diameter, contraction speed, a contraction time period, contraction intervals, contraction strength, and contraction frequency of the fertile ovum.

(5)

The image processing apparatus according to any one of the above-mentioned (1) to (4), in which

the feature amount calculating unit is configured to calculate, as the second feature amount, at least one of a central coordinate, a movement amount, a motion amount, a movement distance, movement speed, movement acceleration, and a movement locus of the fertile ovum.

(6)

The image processing apparatus according to any one of the above-mentioned (1) to (5), further including:

a determining unit configured to determine quality of the fertile ovum on the basis of at least one of the first feature amount and the second feature amount.

(7)

The image processing apparatus according to the above-mentioned (6), in which

the determining unit is further configured to determine the quality of the fertile ovum on the basis of at least one of the first feature amount and the second feature amount and on the basis of quality information of the fertile ovum evaluated on the basis of the images.

(8)

The image processing apparatus according to the above-mentioned (6) or (7), in which

the determining unit is configured to determine the quality of the fertile ovum in accordance with a machine learning algorithm.

(9)

The image processing apparatus according to any one of the above-mentioned (1) to (8), in which

the feature amount calculating unit is further configured to calculate, as the transformation, change of an inner movement amount of the fertile ovum.

(10)

The image processing apparatus according to the above-mentioned (9), in which

the determining unit is further configured to determine one or both of an active period and an inactive period of the fertile ovum on the basis of the shape-change and the change of the movement amount.

(11)

The image processing apparatus according to the above-mentioned (10), in which

the determining unit is configured to determine that a state of the fertile ovum, in which the shape-change per unit time is approximately zero and the change of the movement amount per unit time is approximately zero, is the inactive period.

(12)

The image processing apparatus according to any one of the above-mentioned (1) to (11), further including:

a predicting unit configured to calculate at least one of an incubation rate, an implantation rate, a pregnancy rate, a conception rate, a miscarriage rate, a birthweight, a birth rate, and a breeding value of a grown-up of the fertile ovum on the basis of at least one of the transformation, the first feature amount, and the second feature amount.

(13)

The image processing apparatus according to the above-mentioned (12), in which

the predicting unit is configured to calculate at least one of the incubation rate, the implantation rate, the pregnancy rate, the conception rate, the miscarriage rate, the birthweight, the birth rate, and the breeding value of a grown-up in accordance with a machine learning algorithm.

(14)

The image processing apparatus according to any one of the above-mentioned (1) to (13), in which

the recognizing unit is configured to form mask areas for the plurality of images, respectively, each of the mask areas being along a shape of the fertile ovum, and

the feature amount calculating unit is configured to calculate at least one of the transformation and change of the relative position on the basis of a differential value between one of the mask areas and another one of the mask areas.

(15)

The image processing apparatus according to any one of the above-mentioned (2) to (14), further including:

an image-capture controller unit configured to control an image-capture unit and a light source on the basis of the shape-change, time of capturing the images of the fertile ovum being changed under the control.

(16)

The image processing apparatus according to any one of the above-mentioned (1) to (15), in which

the feature amount calculating unit is configured to calculate at least one of an area of a zona pellucida, an area of inner daughter cells, an area of an inner morula, and an area of an inner blastocyst of the fertile ovum.

(17)

The image processing apparatus according to any one of the above-mentioned (6) to (16), in which

the determining unit is further configured to determine compaction of the fertile ovum on the basis of change of a differential or a ratio of at least one of an area of a zona pellucida, an area of inner daughter cells, an area of an inner morula, and an area of an inner blastocyst of the fertile ovum.

(18)

The image processing apparatus according to any one of the above-mentioned (6) to (16), in which

the determining unit is further configured to determine cell-division time, a number of daughter cells, a symmetric property of daughter cells, or fragmentation of daughter cells of the fertile ovum on the basis of change of a differential or a ratio of at least one of an area of a zona pellucida and an area of inner daughter cells of the fertile ovum.

(19)

An image processing method, including:

obtaining a plurality of images of a fertile ovum captured in time series;

recognizing at least one of a shape of the fertile ovum and a position of the fertile ovum in a well on the basis of the images;

calculating at least one of time-series transformation of the fertile ovum and time-series change of a relative position of the fertile ovum relative to the well, the fertile ovum being held in the well; and

calculating at least one of a first feature amount based on the transformation and a second feature amount based on the change of the relative position.

(20)

A program, that causes an image processing apparatus to execute the steps of:

obtaining a plurality of images of a fertile ovum captured in time series;

recognizing at least one of a shape of the fertile ovum and a position of the fertile ovum in a well on the basis of the images;

calculating at least one of time-series transformation of the fertile ovum and time-series change of a relative position of the fertile ovum relative to the well, the fertile ovum being held in the well; and

calculating at least one of a first feature amount based on the transformation and a second feature amount based on the change of the relative position.

(21)

An observation system, including:

an image-capture unit configured to capture a plurality of images of a fertile ovum in time series; and

an image processing apparatus including

an image obtaining unit configured to obtain the plurality of images captured by the image-capture unit,

a recognizing unit configured to recognize at least one of a shape of the fertile ovum and a position of the fertile ovum in a well on the basis of the images, and

a feature amount calculating unit configured to calculate at least one of time-series transformation of the fertile ovum and time-series change of a relative position of the fertile ovum relative to the well, the fertile ovum being held in the well, and

calculate at least one of a first feature amount based on the transformation and a second feature amount based on the change of the relative position.

(22)

An embryonic development analysis system, including:

processing circuitry configured to:

recognize a shape of one or more cells represented in one or more of a plurality of embryonic development images captured in a time series;

calculate a time-series change of the shape of the one or more cells based on the recognized shape of the one or more cells in the one or more of the plurality of embryonic development images; and

calculate a first feature amount based on the calculated time-series change of the shape.

(23)

The embryonic development analysis system according to the above-mentioned (22), in which

calculating the time-series change of the shape of the one or more cells includes calculating a time-series change of at least one of: a diameter, an area, a volume, and roundness of the one or more cells.

(24)

The embryonic development analysis system according to the above-mentioned (23), in which

calculating the first feature amount includes calculating at least one of: a number of times of contraction, a contraction diameter, contraction speed, a contraction time period, contraction intervals, contraction strength, and contraction frequency of the one or more cells.

The embryonic development analysis system according to the above-mentioned (22), in which

the processing circuitry is further configured to determine a quality of the one or more cells based, at least in part, on the first feature amount.

(26)

The embryonic development analysis system according to the above-mentioned (25), in which

determining the quality of the one or more cells includes using a trained model trained in accordance with a machine learning algorithm.

(27)

The embryonic development analysis system according to the above-mentioned (22), in which

the processing circuitry is further configured to:

recognize a position of the one or more cells in a well as represented in one or more of the plurality of embryonic development images; and

calculate a time-series change of the position of the one or more cells in the well based on the recognized position of the one or more cells in the well as represented in the one or more of the plurality of embryonic development images; and

calculate a second feature amount based on the calculated time-series change of the position.

(28)

The embryonic development analysis system according to the above-mentioned (27), in which

calculating the second feature amount includes calculating at least one of: a central coordinate, a movement amount, a motion amount, a movement distance, movement speed, movement acceleration, and a movement locus of the one or more cells.

(29)

The embryonic development analysis system according to the above-mentioned (27), in which

the processing circuitry is further configured to determine a quality of the one or more cells based, at least in part, on the first feature amount and the second feature amount.

(30)

The embryonic development analysis system according to the above-mentioned (22), in which

the processing circuitry is further configured to calculate a time-series change of an inner movement amount of components of the one or more cells as represented in the one or more of the plurality of embryonic development images.

(31)

The embryonic development analysis system according to the above-mentioned (30), in which

the processing circuitry is further configured to determine one or both of an active period and an inactive period of the one or more cells based on the time-series change of the shape of the one or more cells and the time-series change of the inner movement amount.

(32)

The embryonic development analysis system according to the above-mentioned (31), in which

the processing circuitry is further configured to determine that a state of the one or more cells, in which the time-series change in shape per unit time is approximately zero and the time-series change of the inner movement amount per unit time is approximately zero, is the inactive period.

(33)

The embryonic development analysis system according to the above-mentioned (22), in which

the processing circuitry is further configured to calculate at least one of an incubation rate, an implantation rate, a pregnancy rate, a conception rate, a miscarriage rate, a birthweight, a birth rate, and a breeding value of a grown-up of the one or more cells on the basis of at least one of the time-series change of shape of the one or more cells and the first feature amount.

(34)

The embryonic development analysis system according to the above-mentioned (33), in which

the processing circuitry is further configured to calculate at least one of the incubation rate, the implantation rate, the pregnancy rate, the conception rate, the miscarriage rate, the birthweight, the birth rate, and the breeding value of a grown-up of the one or more cells using a trained model trained using a machine learning algorithm.

(35)

The embryonic development analysis system according to the above-mentioned (22), in which

recognizing the shape of the one or more cells includes forming mask areas for the plurality of embryonic development images, respectively, each of the mask areas being along a shape of the one or more cells, and

calculating the time-series change of the shape of the one or more cells includes calculating the time-series change of the shape based, at least in part, on a differential value between one of the mask areas and another one of the mask areas.

(36)

The embryonic development analysis system according to the above-mentioned (23), further including:

control circuitry configured to control a timing of capturing embryonic development images by the imaging device based on the calculated time-series change of the shape of the one or more cells.

(37)

The embryonic development analysis system according to the above-mentioned (22), in which

the processing circuitry is further configured to calculate at least one of an area of a zona pellucida, an area of inner daughter cells, an area of an inner morula, and an area of an inner blastocyst of the one or more cells.

(38)

The embryonic development analysis system according to the above-mentioned (22), in which

the processing circuitry is further configured to determine compaction of the one or more cells on the basis of change of a differential or a ratio of at least one of an area of a zona pellucida, an area of inner daughter cells, an area of an inner morula, and an area of an inner blastocyst of the fertile ovum.

(39)

The embryonic development analysis system according to the above-mentioned (22), in which

the processing circuitry is further configured to determine cell-division time, a number of daughter cells, a symmetric property of daughter cells, or fragmentation of daughter cells of the fertile ovum on the basis of change of a differential or a ratio of at least one of an area of a zona pellucida and an area of inner daughter cells of the fertile ovum.

(40)

The embryonic development analysis system according to the above-mentioned (22), in which

the processing circuitry is further configured to preprocess the one or more of the plurality of embryonic development images; and

calculate the time-series shape change of the one or more cells using the pre-processed one or more embryonic development images.

(41)

The embryonic development analysis system according to the above-mentioned (40), in which

preprocessing the one or more of the plurality of embryonic development images includes normalizing the one or more of the plurality of embryonic development images.

(42)

The embryonic development analysis system according to the above-mentioned (22), in which

calculating a time-series change in the shape of the one or more cells in the plurality of embryonic development images includes calculating a time-series change in the shape of a fertile ovum in the plurality of embryonic development images.

(43)

The embryonic development analysis system according to the above-mentioned (22), further including:

an imaging device configured to capture the plurality of embryonic development images in a time series.

(44)

The embryonic development analysis system according to the above-mentioned (22), in which

the one or more cells includes a plurality of cells and wherein recognizing a shape of one or more cells includes recognizing a shape of an aggregate of the plurality of cells.

(45)

An embryonic development image analysis method, including:

obtaining a plurality of embryonic development images captured in time series;

recognizing a shape of one or more cells represented in one or more of the plurality of embryonic development images;

calculating a time-series change of the shape of the one or more cells based on the recognized shape of the one or more cells in the one or more of the plurality of embryonic development images; and

calculating a first feature amount based on the calculated time-series change of the shape.

(46)

A non-transitory computer readable medium having stored thereon a program that when executed by a computer causes the computer to execute processing, the processing including:

obtaining a plurality of embryonic development images captured in time series;

recognizing a shape of one or more cells represented in one or more of the plurality of embryonic development images;

calculating a time-series change of the shape of the one or more cells based on the recognized shape of the one or more cells in the one or more of the plurality of embryonic development images; and

calculating a first feature amount based on the calculated time-series change of the shape.

(47)

An embryonic development image processing device, including:

processing circuitry configured to:

recognize a shape of one or more cells represented in one or more of the plurality of embryonic development images;

calculate a time-series change of the shape of the one or more cells based on the recognized shape of the one or more cells in the one or more of the plurality of embryonic development images; and

calculate a first feature amount based on the calculated time-series change of the shape.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

100, 200 observation system

10 incubator

20 observation device

21 image-capture unit

22 light source

23 culture dish group

23a culture dish

30 humidity-temperature-gas controller unit

40 detector unit

50 image processing apparatus

51 image obtaining unit

52 image processing unit

53 recognizing unit

54 feature amount calculating unit

55 image-capture controller unit

56 determining unit

57 predicting unit

58 display controller unit

59 fertile ovum information database

60 display device

70 input unit

F fertile ovum

W well

1. An embryonic development analysis system, comprising:
processing circuitry configured to:
recognize a shape of one or more cells represented in one or more of a plurality of embryonic development images captured in a time series;
calculate a time-series change of the shape of the one or more cells based on the recognized shape of the one or more cells in the one or more of the plurality of embryonic development images; and
calculate a first feature amount based on the calculated time-series change of the shape.

2. The embryonic development analysis system according to claim 1, wherein
calculating the time-series change of the shape of the one or more cells comprises calculating a time-series change of at least one of: a diameter, an area, a volume, and roundness of the one or more cells.

3. The embryonic development analysis system according to claim 2, wherein
calculating the first feature amount comprises calculating at least one of: a number of times of contraction, a contraction diameter, contraction speed, a contraction time period, contraction intervals, contraction strength, and contraction frequency of the one or more cells.

4. The embryonic development analysis system according to claim 1, wherein
the processing circuitry is further configured to determine a quality of the one or more cells based, at least in part, on the first feature amount.

5. The embryonic development analysis system according to claim 4, wherein
determining the quality of the one or more cells comprises using a trained model trained in accordance with a machine learning algorithm.

6. The embryonic development analysis system according to claim 1, wherein the processing circuitry is further configured to:
recognize a position of the one or more cells in a well as represented in one or more of the plurality of embryonic development images; and
calculate a time-series change of the position of the one or more cells in the well based on the recognized position of the one or more cells in the well as represented in the one or more of the plurality of embryonic development images; and
calculate a second feature amount based on the calculated time-series change of the position.

7. The embryonic development analysis system according to claim 6, wherein
calculating the second feature amount comprises calculating at least one of: a central coordinate, a movement amount, a motion amount, a movement distance, movement speed, movement acceleration, and a movement locus of the one or more cells.

8. The embryonic development analysis system according to claim 6, wherein
the processing circuitry is further configured to determine a quality of the one or more cells based, at least in part, on the first feature amount and the second feature amount.

9. The embryonic development analysis system according to claim 1, wherein
the processing circuitry is further configured to calculate a time-series change of an inner movement amount of components of the one or more cells as represented in the one or more of the plurality of embryonic development images.

10. The embryonic development analysis system according to claim 9, wherein
the processing circuitry is further configured to determine one or both of an active period and an inactive period of the one or more cells based on the time-series change of the shape of the one or more cells and the time-series change of the inner movement amount.

11. The embryonic development analysis system according to claim 10, wherein
the processing circuitry is further configured to determine that a state of the one or more cells, in which the time-series change in shape per unit time is approximately zero and the time-series change of the inner movement amount per unit time is approximately zero, is the inactive period.

12. The embryonic development analysis system according to claim 1, wherein
the processing circuitry is further configured to calculate at least one of an incubation rate, an implantation rate, a pregnancy rate, a conception rate, a miscarriage rate, a birthweight, a birth rate, and a breeding value of a grown-up of the one or more cells on the basis of at least one of the time-series change of shape of the one or more cells and the first feature amount.

13. The embryonic development analysis system according to claim 12, wherein
the processing circuitry is further configured to calculate at least one of the incubation rate, the implantation rate, the pregnancy rate, the conception rate, the miscarriage rate, the birthweight, the birth rate, and the breeding value of a grown-up of the one or more cells using a trained model trained using a machine learning algorithm.

14. The embryonic development analysis system according to claim 1, wherein
recognizing the shape of the one or more cells comprises forming mask areas for the plurality of embryonic development images, respectively, each of the mask areas being along a shape of the one or more cells, and
calculating the time-series change of the shape of the one or more cells comprises calculating the time-series change of the shape based, at least in part, on a differential value between one of the mask areas and another one of the mask areas.

15. The embryonic development analysis system according to claim 2, further comprising:
control circuitry configured to control a timing of capturing embryonic development images by the imaging device based on the calculated time-series change of the shape of the one or more cells.

16. The embryonic development analysis system according to claim 1, wherein
the processing circuitry is further configured to calculate at least one of an area of a zona pellucida, an area of inner daughter cells, an area of an inner morula, and an area of an inner blastocyst of the one or more cells.

17. The embryonic development analysis system according to claim 1, wherein
the processing circuitry is further configured to determine compaction of the one or more cells on the basis of change of a differential or a ratio of at least one of an area of a zona pellucida, an area of inner daughter cells, an area of an inner morula, and an area of an inner blastocyst of the fertile ovum.

18. The embryonic development analysis system according to claim 1, wherein
the processing circuitry is further configured to determine cell-division time, a number of daughter cells, a symmetric property of daughter cells, or fragmentation of daughter cells of the fertile ovum on the basis of change of a differential or a ratio of at least one of an area of a zona pellucida and an area of inner daughter cells of the fertile ovum.

19. The embryonic development analysis system according to claim 1, wherein
the processing circuitry is further configured to preprocess the one or more of the plurality of embryonic development images; and
calculate the time-series shape change of the one or more cells using the preprocessed one or more embryonic development images.

20. The embryonic development analysis system according to claim 19, wherein
preprocessing the one or more of the plurality of embryonic development images comprises normalizing the one or more of the plurality of embryonic development images.

21. The embryonic development analysis system according to claim 1, wherein
calculating a time-series change in the shape of the one or more cells in the plurality of embryonic development images comprises calculating a time-series change in the shape of a fertile ovum in the plurality of embryonic development images.

22. The embryonic development analysis system according to claim 1, further comprising:
an imaging device configured to capture the plurality of embryonic development images in a time series.

23. The embryonic development analysis system according to claim 1, wherein the one or more cells comprises a plurality of cells and wherein recognizing a shape of one or more cells comprises recognizing a shape of an aggregate of the plurality of cells.

24. A embryonic development image analysis method, comprising:
obtaining a plurality of embryonic development images captured in time series;
recognizing a shape of one or more cells represented in one or more of the plurality of embryonic development images;
calculating a time-series change of the shape of the one or more cells based on the recognized shape of the one or more cells in the one or more of the plurality of embryonic development images; and
calculating a first feature amount based on the calculated time-series change of the shape.

25. A non-transitory computer readable medium having stored thereon a program that when executed by a computer causes the computer to execute processing, the processing comprising:
obtaining a plurality of embryonic development images captured in time series;
recognizing a shape of one or more cells represented in one or more of the plurality of embryonic development images;
calculating a time-series change of the shape of the one or more cells based on the recognized shape of the one or more cells in the one or more of the plurality of embryonic development images; and
calculating a first feature amount based on the calculated time-series change of the shape.

26. An embryonic development image processing device, comprising:
processing circuitry configured to:
recognize a shape of one or more cells represented in one or more of the plurality of embryonic development images;
calculate a time-series change of the shape of the one or more cells based on the recognized shape of the one or more cells in the one or more of the plurality of embryonic development images; and
calculate a first feature amount based on the calculated time-series change of the shape.
